(19) United States
(12) Patent Application Publication
(10) Pub. No.: US 2026/0056336 A1
(43) Pub. Date: Feb. 26, 2026

(54) CZT DETECTORS AND METHODS OF USE THEREOF

(71) Applicant: GEORGIA TECH RESEARCH CORPORATION, Atlanta, GA (US)

(72) Inventors: Steven Biegalski, Atlanta, GA (US); Ian Schreiber, Atlanta, GA (US)

(21) Appl. No.: 19/195,947

(22) Filed: May 1, 2025

Related U.S. Application Data
(60) Provisional application No. 63/686,962, filed on Aug. 26, 2024.

(51) Int. Cl. G01T 1/24; G01T 1/36

(52) U.S. Cl. CPC G01T 1/24; G01T 1/366

(57) ABSTRACT

Fission reactions within a molten salt reactor may produce gaseous fission products. These fission products may be removed through a variety of methods. However, proper removal of such fission products requires a thorough understanding of the proportion of gaseous space to fluid space within the component being interrogated, known as the void fraction. The present invention provides a means for determining the void fraction within such a component utilizing an enrich cadmium zinc telluride detector to produce collimated radiation data. The collimated radiation data may then be used to compute a mean void fraction across the domain being interrogated.

### RELATED APPLICATION

The present application relates and claims priority to U.S. Provisional Application No. 63/686,962, filed on Aug. 26, 2024, which is hereby incorporated by reference in its entirety.

### TECHNICAL FIELD

The described examples relate generally to systems, devices, and techniques for detecting gamma radiation in a reactor system with a cadmium zinc telluride detector and utilizing such detections to determine a void fraction within reactor system components.

### BACKGROUND

Molten salt reactors (MSRs) offer an approach to nuclear power that utilizes molten salts as their nuclear fuel in place of the conventional solid fuels used in light water reactors. Advantages include efficient fuel utilization and enhanced safety (largely due to replacing water as a coolant with molten salt). In an MSR, fission reactions occur within a molten salt composition housed within a reactor vessel. Radionuclides exist within this system as a result of the fission reactions and emit gamma rays characteristic of each radionuclides. The gamma ray spectrum can be used to inventory radionuclides and quantify the materials that are within the reactor system, which is advantageous for ensuring proper operation of the MSR. Gamma ray spectroscopy can then be used for inventory control and to understand the composition of the system.

Current radiation detection devices use sensitive scientific instruments which need to be liquid nitrogen cooled and can take up a large amount of space, such as high purity germanium detectors (functional at 88K). As these detectors are not able to function in a reactor environment due to the high temperature and high radiation, samples from the reactor are typically physically removed and taken to a different location to be tested by the instrumentation. Standard cadmium zinc telluride (CZT) gamma ray detector systems are not able to work in a reactor, as they absorb a large number of neutrons and any gamma ray absorption is effectively overwhelmed by the neutron absorption, rendering a CZT gamma ray detector useless in such a high neutron environment.

MSR systems may require a quantity of fuel salt for operation. The fuel salt may include LiF—BeF₂—UF₄, though other compositions of fuel salts may be utilized as fuel salts within the reactor system. The fissile material in the fuel salt is used create thermal power via fission reactions therein. Upon fission reaction, a variety of fission products may be produced, including some that are gaseous. These gaseous fission products may become entrained in a molten salt loop. One such gaseous fission product, xenon-135, a byproduct of decay of iodine-135, is known as a neutron poison. Xenon-135 may significantly leech reactivity off the reactor. Other gaseous species, such as helium, may also become entrained in the molten salt loop. The fraction, by volume, of the loop occupied by gas is referred to as the void fraction. Void fraction affects reactivity and consequently the power dynamics of the reactor.

### SUMMARY

In one example, a radiation detection system is disclosed. The radiation detection system includes a cadmium zinc telluride (CZT) detector includes at least one enriched CZT crystal. The radiation detection system further includes a collimator assembly coupled to and interposed between the CZT detector and a molten salt reactor system and operable to filter gamma rays emitted from radionuclides of a domain of the molten salt reactor system thereby producing filtered gamma rays. The CZT detector is operable to receive the filtered gamma rays and produce spectroscopy data representative of an inventory of radionuclides within the domain of the molten salt reactor system from the filtered gamma rays. The at least one enriched CZT crystal is substantially devoid of cadmium-113 isotopes.

In another example, the radiation detection system further includes an analysis module operable to determine a void fraction of the domain of the molten salt reactor system by comparing a measurement of gamma counts from the spectroscopy data to an ideal gamma count.

In another example, the ideal gamma count is an expected observed gamma count of the domain with a void fraction of zero.

In another example, the domain of the molten salt reactor system is in a high neutron flux region of the molten salt reactor system.

In another example, the domain is an internal volume of piping of a molten salt loop of the molten salt reactor system.

In another example, the domain is an internal volume of a drain tank of the molten salt reactor system.

In another example, the domain is an internal volume of a primary heat exchanger of the molten salt reactor system.

In another example, the analysis module is further operable to consider characteristics of the domain of the molten salt reactor system.

In another example, the characteristics include a composition of the molten salt disposed within the domain and a composition of a vessel housing the molten salt disposed within the domain.

In another example, the characteristics further include a distance between the CZT detector and the domain, a geometric shape of the vessel housing the molten salt, a radius of the vessel housing the molten salt, and a thickness of walls of the vessel housing the molten salt.

In another example, the analysis module is further operable to determine a mean void fraction of the domain of the molten salt reactor system by comparing the measurement of gamma counts from the spectroscopy data over a time period of taking the spectroscopy data.

In another example, the mean void fraction is determined based on an upper bound determination or a lower bound determination.

In another example, the mean void fraction is an isotropic mean void fraction determined based on an isotropic flow assumption.

In another example, the CZT crystal includes at least 99% of cadmium-106, cadmium-108, cadmium-110, cadmium-111, cadmium-112, cadmium-114, cadmium-116, or combinations thereof.

In another example, the CZT crystal consists essentially of cadmium-116.

In another example, the CZT crystal is operable to interact with the filtered gamma rays and produce a charged pulse and the CZT detector further includes a multichannel analyzer module operable to convert the charged pulse from the CZT crystal into a shaped voltage pulse and an amplifier module operable to shape nuclear radiation measurements.

In another example, the collimator assembly includes a thermal insulation material operable to thermally insulate the CZT detector.

In yet another example, the collimator assembly further includes a neutron filter operable to filter background noise from contacting the CZT detector.

In one example a method for determining a mean void fraction of a domain of molten fuel salt in a high neutron flux environment is disclosed. The method includes obtaining, by a cadmium zinc telluride (CZT) detector coupled to a molten salt reactor system including the domain of molten fuel salt, gamma ray spectrum data of the domain of molten fuel salt. The CZT detector includes at least one enriched CZT crystal. The method further includes comparing, by an analysis module, a counts observed from the gamma ray spectrum data to an ideal activity of the domain of molten fuel salt. The method further includes inputting into the CZT detector, a plurality of characteristics of the domain of molten fuel salt. The method further includes determining, by an analysis module of the CZT detector, the mean void fraction of the domain based on the comparison and the plurality of characteristics.

In another example, the ideal gamma count is an expected observed gamma count of the domain with a void fraction of zero and the plurality of characteristics includes a composition of the molten fuel salt disposed within the domain, a composition of a vessel housing the molten fuel salt, a distance between the CZT detector and the domain of molten fuel salt, a geometric shape of the vessel, a radius of the vessel, and a thickness of walls of the vessel.

In one example, an enriched cadmium zinc telluride (CZT) gamma ray detector is disclosed. The example enriched CZT gamma ray detector includes at least one CZT crystal. The at least one CZT crystal comprises cadmium-116, cadmium-106, and cadmium-108. The example enriched CZT gamma ray detector further includes a collimator. The collimator is configured to couple to a molten salt loop of a molten salt reactor (MSR) system. The collimator is configured to provide radiation shielding to the enriched CZT gamma ray detector. The collimator is configured to provide neutron filtration to the enriched CZT gamma ray detector. The collimator is configured to provide thermal protection to the enriched CZT gamma ray detector. The collimator includes a hollow section comprising inert gas. The enriched CZT gamma ray detector is operable to measure gamma radiation from the MSR system. The example enriched CZT gamma ray detector may further include at least one amplifier. The example enriched CZT gamma ray detector may further include an analysis module. The example enriched CZT gamma ray detector may further include a multi-channel analyzer (MCA) module configured to produce pulse height data corresponding to the gamma radiation from the MSR system.

In another example, the at least one CZT crystal is substantially devoid of cadmium-113.

In another example, the at least one CZT crystal comprises at least 99% of cadmium-106, cadmium-108, cadmium-110, cadmium-111, cadmium-112, cadmium-114, cadmium-116, or combinations thereof.

In another example, the CZT crystal consists essentially of cadmium-116.

In another example, the collimator is hermetically sealed to piping of the molten salt loop.

In one example, a method of determining a mean void fraction of a domain of molten fuel salt in a high neutron flux environment is disclosed. The example method includes obtaining, using a CZT detector coupled to the domain of molten fuel salt, gamma ray spectrum data of the domain of molten fuel salt comprising an unknown void fraction. The example method further includes comparing, using a multichannel analyzer of the CZT detector, the counts observed from the gamma ray spectrum data to an expected activity of the domain of molten fuel salt. The example method further includes inputting into the CZT detector, a plurality of characteristics of the domain of molten fuel salt, the plurality of characteristics associated with the expected activity. The example method further includes determining, by an analysis module of the CZT detector, the mean void fraction of the domain based on the comparison.

In another example, the mean void fraction is based on a lower bound of the mean void fraction.

In another example, the mean void fraction is based on an upper bound of the mean void fraction.

In another example, the mean void fraction is based on an isotropic void distribution.

In another example, the CZT detector is the enriched CZT gamma ray detector of the present disclosure.

In another example, the known mean void fraction is zero.

In one example, a system is disclosed. The example system includes a cadmium zinc telluride (CZT) gamma ray detector connected to a molten salt loop of a molten salt reactor (MSR) system. The molten salt loop includes a pump operable to circulate molten fuel salt through a reactor of the MSR system causing fission reaction and producing fission products in the molten fuel salt. The CZT gamma ray detector includes at least one CZT crystal comprising cadmium-116, cadmium-106, and cadmium-108. The fission products include gaseous fission products. the CZT gamma ray detector is operable to receive gamma ray spectrum data of the molten fuel salt of a chord of piping of the molten salt loop. the CZT gamma ray detector includes a collimator arranged between the CZT gamma ray detector and the piping of the molten salt loop. the chord of piping has a void fraction associated with an amount of gaseous fission products within the molten salt loop. The example system may further include an analysis module in communication with the CZT gamma ray detector configured to calculate a chordal mean void fraction of the chord of the piping of the molten salt loop by calculating a void fraction based on the counts observed by the CZT gamma ray detector and comparing the counts observed to an expected count.

### BRIEF DESCRIPTION OF THE DRAWINGS

FIG. 1 illustrates a schematic representation of an example molten salt reactor system.

FIG. 2 illustrates an isometric view of an example arrangement of radiation detection systems on a molten salt reactor system.

FIG. 3 illustrates a functional diagram of an example radiation detection system.

FIG. 4 illustrates an exploded view of an example enriched CZT detector.

FIG. 5 illustrates an example enriched CZT detector array.

FIG. 6 illustrates a cross-sectional view of an example radiation detection system installed in a reactor system.

FIG. 7 illustrates an isometric view of an example radiation detection system.

FIG. 8 illustrates a transparent and exploded view of the example radiation detection system of FIG. 7.

FIG. 9A illustrates a simplified depiction of a chord of piping and an example radiation detection system.

FIG. 9B illustrates a simplified depiction of a chord of piping in a lower bound scenario and an example radiation detection system.

FIG. 9C illustrates a simplified depiction of a chord of piping in an upper bound scenario and an example radiation detection system.

FIG. 9D illustrates a simplified depiction of a chord of piping in an isotropic distribution scenario and an example radiation detection system.

FIG. 10 illustrates a flow diagram for an example method for determining a mean void fraction of a domain of molten fuel salt in a high neutron flux environment.

FIG. 11 illustrates an example analysis system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

As used herein, “real time” refers to collecting data directly from a detector in proximity to a reactor, such that a user has the opportunity to observe the radiation information as it is being generated by a detector as it is detected within a reactor system.

“Equal” refers to equal values or values within the standard of error of measuring such values. “Substantially equal” or “about” refers to an amount that is within 3% of the value recited.

As used herein, “enriched CZT detector,” “enriched cadmium,” and “enriched CZT crystal” refers to components with low to no ¹¹³Cd in the cadmium within the detectors CZT crystal. For example, a CZT detector with less than 1% ¹¹³Cd in the cadmium within the CZT crystal. The components may be said to be enriched with ¹¹⁶Cd thereby essentially replacing cadmium-113 isotopes.

The following disclosure relates to systems, devices, and techniques for capturing radiation spectra data from a reactor system and determining a void fraction within components of an MSR system based on the captured data. The radiation detection system of the present disclosure enables determination of the void fraction by utilizing an enriched CZT detector system. MSR systems create a variety of fission products through fission reaction within the reactor core. Void fraction determination may be useful to understanding the composition of molten fuel salt within the MSR system and particularly for understanding the quantity or proportion of gaseous species within the MSR system. The composition it altered by the generation of fission products produced as a consequence of operation. These fission products are not limited to those produced in single-step reactions between fuel (e.g., U-235) and neutrons, but may also arise from decay of short-lived direct fission products. One notable fission product, iodine-135 quickly decays into xenon-135. Xenon-135 is a gas at reactor conditions and is known as a neutron poison. With a thermal neutron cross section of up to three million barns, xenon-135 may significantly leech reactivity from the reactor, consequently reducing power output of the MSR system.

Xenon-135, and other fission products, are typically removed through sparging, burnup, or through decay. However, sparging may be inefficient and add the sparging gas into the molten salt loop, consequently increasing the void fraction of the molten salt loop, decreasing the fuel inventory in the core, and decreasing the power output of the system. Burnup occurs where xenon-135 captures a neutron and transmutes into stable xenon-135. Otherwise, xenon-135 with a half-life of about 9.2 hours decays to cesium-135 through beta minus decay. However, if the reactor were to shut down, thereby cutting the neutron flux, xenon-135 would continue to be produced through the decay of iodine-134 but not be burned up through neutron capture. Thus, the inventory of xenon-135 would increase and may cause the reactor to not have enough excess reactivity to restart, termed the iodine pit. This is undesirable and further complicates reactor operation.

Overall, xenon-135, and other gaseous fission products, complicate the management of safe reactor operations. In order to tackle xenon gas management more elegantly, a method, system, and apparatus is needed to quantify the amount of gas in the MSR system to provide the necessary information to make a proper decision on gas management. As such, there is a need for a radiation detection system for both collecting radiation spectra data from a reactor system and determining a void fraction therein based on said collected spectra data.

Radiation spectra data may be captured by a cadmium zinc telluride (CZT) detector, which may be used in MSR systems for material accountancy by supplying gamma ray spectroscopy. The gamma ray spectra provided by a CZT detector may be used to determine the void fraction within components of an MSR system by correlating the gamma rays with radionuclides within the molten salt (i.e., radioactive fission products). However, due to the fission reaction occurring within the reactor core, traditional CZT detectors are impractical to use. This is because cadmium-113, a common cadmium isotope found in traditional CZT detectors, has a high neutron absorption cross-section. When operating near an MSR system, and other high neutron flux environments, the CZT detector will have an extremely high neutron absorption rate (consequence of the cadmium-113). This high neutron absorption will create a count saturation, causing any resulting spectra to be essentially useless. Thus, there is a need to provide not only a method for determining the void fraction within an MSR system, but an apparatus capable of providing reliable data for such a determination. To address such a need, the present invention is directed to a radiation detection system including a CZT detector with an enriched CZT crystal thereby enabling function in close proximity to the high neutron flux environment of a MSR system and a method of determining the mean void fraction of the MSR system utilizing spectra captured by such an enriched CZT detector.

The CZT detector is enriched in the sense that it has low to no cadmium-113 isotopes within the cadmium of the CZT crystal. In one example, the enriched CZT gamma ray detector comprises at least one CZT crystal with low to no ¹¹³Cd in the cadmium of the CZT crystal. In one example, the CZT crystal includes at most 1% ¹¹³Cd of total cadmium in the crystal. In one example, the cadmium within the CZT crystal consists essentially of ¹⁰⁶Cd, ¹⁰⁸Cd, ¹¹⁰Cd, ¹¹¹Cd, ¹¹²Cd, ¹¹⁴Cd, ¹¹⁶Cd, or combinations thereof. In another example, the cadmium within the CZT crystal consists essentially of ¹⁰⁶Cd, ¹¹⁶Cd, ¹⁰⁸Cd, or combinations thereof. In another example, the cadmium within the CZT crystal consists essentially of ¹¹⁶Cd. In another example, the cadmium within the CZT crystal includes only ¹⁰⁶Cd, ¹⁰⁸Cd, ¹¹⁰Cd, ¹¹¹Cd, ¹¹²Cd, ¹¹⁴Cd, ¹¹⁶Cd, or combinations thereof. In another example, the cadmium within the CZT crystal includes only ¹⁰⁶Cd, ¹¹⁶Cd, ¹⁰⁸Cd, or combinations thereof. In yet another example, the cadmium within the CZT crystal includes only ¹¹⁶Cd. Advantageously, by providing a CZT detector that is substantially devoid of ¹¹³Cd, the CZT detector may be used to capture gamma ray spectrum data from an MSR system (or any area of high neutron flux). The lack of ¹¹³Cd in the CZT detector allows the CZT detector to capture the gamma ray data without being overwhelmed, otherwise resulting in usable and inaccurate measurements. The CZT detector may include an array of CZT crystals or may include only a single CZT crystal.

The CZT detector may be equipped with additional components to facilitate spectra data generation. For example, the CZT detector may include a multichannel analyzer (MCA) generally operable to characterize incoming voltage pulses. The CZT detector may include an amplifier generally operable to shape and amplify the pulse signals. The CZT detector may include an analysis module or analytical system generally operable to conduct analysis on the spectra produced by the detector. The CZT detector may include a high voltage power supply generally operable to supply power to the detector and related components. The CZT detector may also include a collimator generally operable to redirect, filter, and/or narrow the radiation emitting from the molten fuel salt of the MSR system. The collimator may be configured to provide thermal insulation and neutron filtering. Furthermore, the collimator may facilitate hermetic sealing of the CZT detector onto the MSR system. For example, the collimator may be bolted onto piping of the MSR system by a flange and include plastic, epoxy resin, glass, metal, or ceramic materials between the flange and a corresponding flange of the piping of the MSR system.

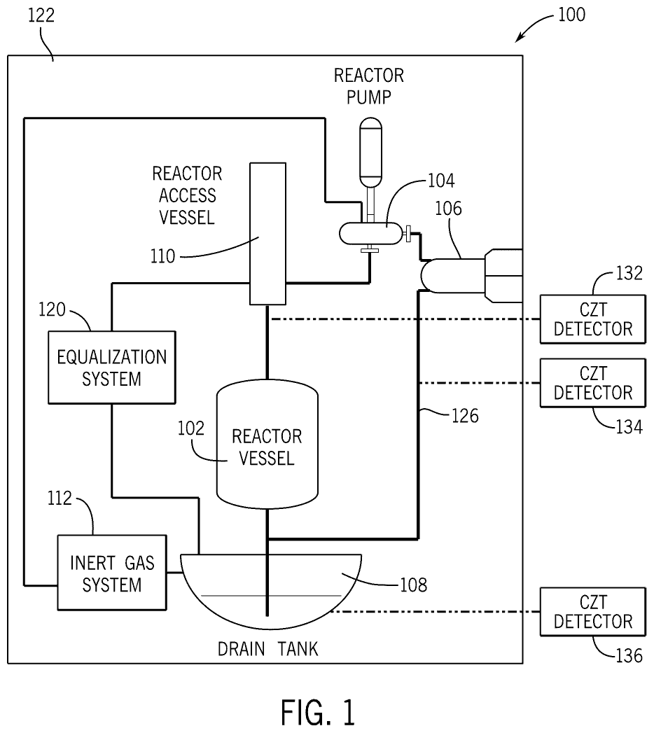

Turning to the drawings, for purposes of illustration, FIG. 1 illustrates a schematic representation of an example molten salt reactor system 100. In one example, molten salt reactor system 100 utilizes a molten salt with enriched uranium (e.g., high-assay low-enriched uranium) dissolved therein and configured to create thermal power via nuclear fission reactions. The composition of the fuel salt may be LiF—BeF₂—UF₄, though other compositions of fuel salts may be utilized as fuel salts within the reactor system 100 (e.g., chloride-based salt). The fuel salt within the system 100 is heated to high temperatures (about 700° C.) and melts as the system 100 is heated. In one example, the molten salt reactor system 100 includes a reactor vessel 102 housing a reactor core configured to facilitate or otherwise cause the fission reactions to occur, a fuel salt pump 104 configured to pump the molten fuel salt throughout the system, such that the molten fuel salt re-enters the reactor vessel 102 after flowing through the heat exchanger 106, and piping in between each component 126, thereby establishing a molten salt loop. The molten salt reactor system 100 may also include additional components, such as, but not limited to, drain tank 108 and reactor access vessel 110. The drain tank 108 may be configured to store the fuel salt once the fuel salt is in the reactor system 100 but in a subcritical state, and also act as storage for the fuel salt if power is lost in the system 100. The reactor access vessel 110 may be configured to allow for introduction of small pellets of fissile material (e.g., uranium or plutonium) or beryllium into the MSR system 100 as necessary to bring the reactor to a critical state and compensate for depletion of fissile material or otherwise balance the chemistry of the molten fuel salt.

The molten salt reactor system 100 may further include an inert gas system 112 to provide inert gas (e.g., nitrogen) to a head space of the drain tank 108, among other functions. The inert gas system 112 may further relieve inert gas from the headspace of the drain tank 108 as needed. The inert gas system 112 is therefore operable to maintain pressurized inert gas in the headspace of the drain tank 108 that is sufficient to substantially prevent the flow of molten fuel salt into the drain tank during normal operations. In one example, the inert gas system 112 is operable to maintain a pressure below atmospheric pressure within the headspace. For example, with the headspace of the drain tank 108 pressurized by the inert gas system 112, molten fuel salt may generally circulate between the reactor vessel 102 and the primary heat exchanger 106 without substantially draining into the drain tank 108. In some cases, the inert gas system 112 may be configured to supply inert gas to the headspace of various other components of the molten salt reactor system 100, such as to the headspace of the reactor access vessel 110, to the seal of reactor pump 104, among other components. Upon the occurrence of a shutdown event, the inert gas system 112 may cease providing inert gas to the head space of the drain tank 108, and other components to which the system 112 supplies inert gas. Consequently, this causes the pressure of the headspace of the drain tank 108 to decrease, which causes the fuel salt to gravitationally drain to the drain tank 108, which may be disposed at a lowermost section of the MSR system 100. Advantageously, in the event of a loss of power, emergency situation, or other failure event, the inert gas system 112 may allow the fuel salt to drain into the drain tank 108 rather than circulating to the reactor vessel 102, passively, thereby potentially avoiding pressure build up during such loss of power or other failure event.

The molten salt reactor system 100 may further include an equalization system 120 to work in conjunction with the inert gas system 112. The equalization system 120 is operable to equalize the pressure between the headspace of the drain tank 108 and the reactor vessel 102 upon the occurrence of a shutdown event. In this regard, the equalization system 120 may be operable to fluidically couple (via opening one or more valves) the head space of the drain tank 108 and the reactor vessel 102 to reduce or eliminate the pressure differential, thereby allowing the fuel salt to readily flow into the drain tank upon the shutdown event as described with reference to the inert gas system 112.

MSR system 100 may include or otherwise employe the radiation detection systems of the present disclosure. in this regard, MSR system 100 may implement or otherwise include one or more enriched CZT detectors, as described in greater detail below. For example, the MSR system 100 may include a first enriched CZT detector 132, a second enriched CZT detector 134, and/or a third CZT detector 136; however, less or more may be included based on the need. CZT detectors 132, 134, 136 may be positioned outside the reactor enclosure 122 and be positioned towards or otherwise directed towards certain salt bearing components. In this regard, CZT detectors 132, 134, 136 may be operable to gamma radiation given off by the salt bearing components to which they are facing. As will be discussed in greater detail herein, CZT detectors 132, 134, 136 may be operable to determine a void fraction within the salt bearing components to which they are facing. As will be understood and appreciated, the example shown in FIG. 1 represents merely one example environment in which the enriched CZT detector may be utilized. It will be understood that the enriched CZT detector described herein may be used in and with substantially any other environment or high neutron generating system. Further, CZT detectors may be placed proximal to and directed towards other salt-bearing components than those illustrated in FIG. 1, for example, the reactor vessel 102, the reactor access vessel 110, the primary heat exchanger 106, or other salt-bearing components.

As illustrated by the dotted lines of FIG. 1, a CZT detector may be said to face or is otherwise be directed towards a salt-bearing component when at least a portion thereof is aimed at said salt-bearing components, such that radiation emitted from the salt-bearing component may be received by the CZT detector.

The MSR system 100 of FIG. 1 illustrates a first enriched CZT detector 134 directed to a cold leg of the molten salt loop 126 of the MSR system 100. The cold leg of the molten salt loop 126 may refer to piping downstream of the primary heat exchanger 106 receiving cooled molten fuel salt. This may enable the first enriched CZT detector 112 to detect radiation emitted from molten salt within the cold leg. With this information, the void fraction within this portion of piping may be determined. FIG. 1 also illustrates second enriched CZT detector 132 directed towards a hot leg of the molten salt loop of the MSR system 100. The hot leg of the molten salt loop 126 may refer to piping upstream of the primary heat exchanger and directly downstream of the reactor vessel 102 receiving heated molten fuel salt. This may enable the second enriched CZT detector 132 to detect radiation emitted from molten salt within the hot leg. With this information, the void fraction within this portion of piping may be determined. FIG. 1 further illustrates a third CZT detector 136 directed towards the drain tank 108. This may enable the third enriched CZT detector 136 to detect radiation emitted from the drain tank 108. This may enable the third enriched CZT detector 136 to determine the void fraction with the drain tank. While this configuration is advantageous for determining void fraction within the hot leg and cold leg of the molten salt loop 126 and the drain tank 108, FIG. 1 illustrates merely one example arrangement of enriched CZT detectors. One of ordinary skill in the art will appreciate that the enriched CZT detectors may be arranged differently to determine the void fraction within other components of the MSR system 100. For example, the enriched CZT detectors may be configured to determine the void fraction within the reactor access vessel 110, the pump 104, the heat exchanger 106, or the drain tank 108. Additionally, one of ordinary skill in the art will appreciate that while FIG. 1 illustrates three enriched CZT detectors, more or fewer may be included in the system.

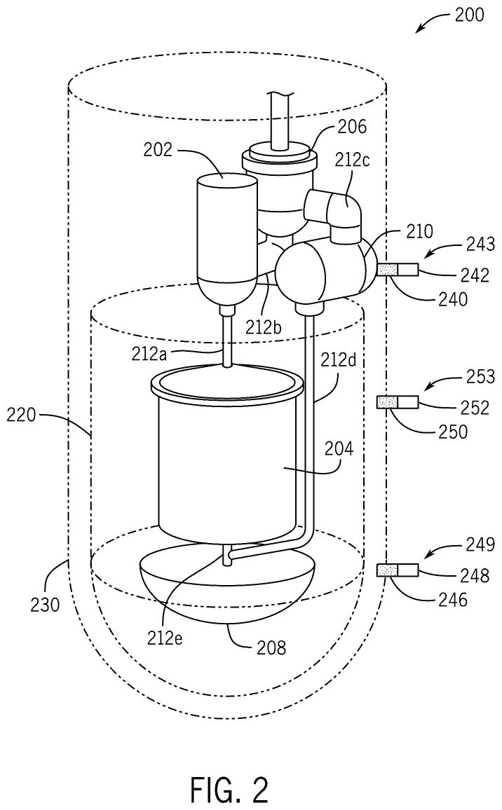

FIG. 2 illustrates an example enriched CZT detector arrangement on an example molten salt reactor system 200. The example MSR system 200 may be substantially analogous to the example MSR system 100, and include a reactor vessel 204, a reactor access vessel 202, a heat exchanger 210, and a drain tank 208, a pump 206, a reactor enclosure 230 and piping between each of the foregoing (212a, 212b, 212c, 212d, 212e) collectively defining a molten salt loop. The example MSR system 200 may also include, a first shielding layer 220 encompassing the reactor vessel 204 and drain tank 208.

Molten salt reactor system 200 may further include a plurality of radiation detection systems 243, 253, 249 arranged throughout the reactor enclosure 230 and operable to capture radiation emitted from components disposed therein (e.g., gamma rays). In this regard, each radiation detection system 243, 253, 249 may be disposed outside the reactor enclosure 230 but partially penetrating the reactor enclosure. Each radiation detection system may include a collimator and an enriched CZT detector. For example, radiation detection system 243 includes a first collimator 240 and a first enriched CZT detector 242; radiation detection system 253 includes a second collimator 250 and a second enriched CZT detector 252; and radiation detection system 249 includes a third collimator 246 and a third enriched CZT detector 248. Each enriched CZT detector 242, 252, 248 may be substantially devoid of cadmium-113 isotopes as described herein.

In this example configuration, the first collimator 210 and first enriched CZT detector 212 are positioned and sealed within the reactor enclosure 230 and proximal to the heat exchanger 210. This configuration enables the first radiation detection system 243 to capture radiation data (e.g., gamma ray data) from the heat exchanger 210 and subsequently determine the void fraction within the heat exchanger 210. In this example configuration, the second collimator 250 and second enriched CZT detector 252 are positioned and sealed within the reactor enclosure 230 and proximal to piping 212d. This configuration enables the second radiation detection system 253 to capture radiation data from piping 212d and subsequently determine the void fraction within piping 212d. In this example configuration, the third collimator 246 and second enriched CZT detector 248 are positioned and sealed within the reactor enclosure 230 and proximal to the drain tank 2008. This configuration enables the third radiation detection system 249 to capture radiation data from the drain tank 208 and subsequently determine the void fraction within the drain tank 208.

The radiation detection system may be equipped with a collimator positioned proximal to the CZT detector and operable to filter, narrow, or otherwise focus the gamma radiation received towards the CZT detector. The collimator may generally be arranged between the CZT detector and the component or area being analyzed. The collimator may be generally operable to focus the radiation measurement on a specific part or region of the system for measurement by the CZT detector.

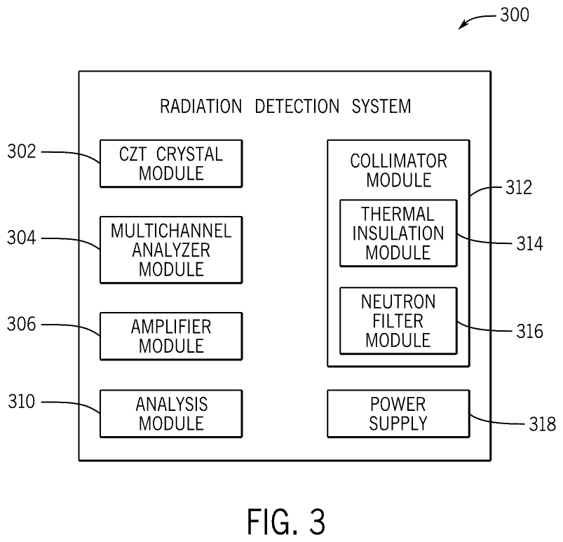

FIG. 3 illustrates a functional diagram of a radiation detection system 300. The example radiation detection system 300 may generally include a CZT crystal module 302, a multichannel analyzer (MCA) module 304, an amplifier module 306, an analysis module 310, and a power supply 318. Radiation detection system 300 may further include a collimator module 312, which may generally include or support a thermal insulation module 314 and a neutron filter module 316. The CZT crystal module 302 may be generally operable to function as a semiconductor and interact with ionizing radiation (e.g., gamma rays) effectively communicating a charged pulse. In this regard, the CZT crystal module 302 may receive gamma radiation emitted from certain salt-bearing components to which it faces and collect data representative of radionuclides therein. The current from the CZT crystal module 302 may be pre-amplified, amplified, shaped, and transmitted. The CZT crystal module 302 may be an enriched CZT crystal as described herein. In this regard, the cadmium of the CZT crystal may be substantially devoid of cadmium-113 and generally comprise cadmium-106, cadmium-108, cadmium-110, cadmium-111, cadmium-112, cadmium-114, and cadmium-116. As previously discussed, CZT detectors may be utilized in relatively high radiation environments but can be saturated with counts in environments exceeding 105 gamma rays cm⁻² s⁻¹. This is primarily due to the presence of cadmium-113, which has a high neutron absorption cross-section. Thus, when a CZT detector including amounts of cadmium-113 is operated near a nuclear reactor (e.g., MSR system 100 and 200) or high neutron flux environment the detector is essentially overwhelmed with gamma rays rendering any resulting spectra worthless. Consequently, by providing a CZT crystal module 302 that is substantially devoid of cadmium-113, this negative consequence is avoided, and usable spectra may be obtained.

In one example, the CZT crystal module 302 includes less than 1% cadmium-113. In another example, the CZT crystal module 302 includes less than 0.1% cadmium-113. However, the CZT crystal module 302 may include varying amounts of cadmium isotopes to effectuate radiation detection in high radiation environments. For example, CZT crystal module 302 may have low to no cadmium-113 in the cadmium of the CZT crystal module 302. As another example, the CZT crystal module may comprise at most 1% cadmium-113 of total cadmium in the crystal. In another example, the cadmium within the CZT crystal module 302 consists essentially of cadmium-106, cadmium-108, cadmium-110, cadmium-111, cadmium-112, cadmium-114, cadmium-116 or combinations thereof. In another example, the cadmium within the CZT crystal consists essentially of cadmium-106, cadmium-116, cadmium107, or combinations thereof. In another example, the cadmium within the CZT crystal consists essentially of cadmium-116. In another example, the cadmium within the CZT crystal comprises only cadmium-106, cadmium-108, cadmium-110, cadmium-111, cadmium-112, cadmium-114, cadmium-116, or combinations thereof. In another example, the cadmium of the CZT crystal module 302 comprises only cadmium-106, cadmium-116, cadmium-108, or combinations thereof. In embodiments, the cadmium of the CZT crystal module 302 comprises only cadmium-116.

In another example, the cadmium within the CZT crystal module 302 includes at most 1% cadmium-113. In another example, the cadmium within the CZT crystal module 302 includes at most 0.9%, 0.8%, 0.7%, 0.6%, 0.5%, 0.4%, 0.3%, 0.2%, 0.1%, 0.01%, or 0.001% ¹¹³Cd. In one example, the cadmium within the CZT crystal includes 99%, 99.1%, 99.2%, 99.3%, 99.4%, 99.5%, 99.6%, 99.7%, 99.8%, 99.9%, 99.99%, or 99.999% ¹⁰⁶Cd, ¹⁰⁸Cd, ¹¹⁰Cd, ¹¹¹Cd, ¹¹²Cd, ¹¹⁴Cd, ¹¹⁶Cd, or combinations thereof. In one example, the cadmium within the CZT crystal includes 99%, 99.1%, 99.2%, 99.3%, 99.4%, 99.5%, 99.6%, 99.7%, 99.8%, 99.9%, 99.99%, or 99.999% ¹⁰⁶Cd, ¹¹⁶Cd, ¹⁰⁸Cd, or combinations thereof. In yet another example, the cadmium within the CZT crystal includes 99%, 99.1%, 99.2%, 99.3%, 99.4%, 99.5%, 99.6%, 99.7%, 99.8%, 99.9%, 99.99%, or 99.999% ¹¹⁶Cd.

The example radiation detection system 300 may include means to convert charge produced by interaction between radiation (e.g., gamma rays) and the CZT crystal module 302 into a shaped voltage pulse (sometimes referred to as “gamma ray data”). For example, the radiation detection system 300 may include a multichannel analyzer (MCA) module 304 generally operable to convert charge into a shaped voltage pulse. The MCA module 304 may be a computer system for performing multi-channel analysis. In one embodiment, the MCA module 304 is coupled to the radiation detection system 300 and a processor. The amplitude of the shaped voltage pulse may be proportional to the energy deposited on the enriched CZT crystal module 302 by gamma rays.

The MCA module 304 may be configured to produce pulse height data corresponding to the gamma ray data. For clarity, the MCA module 304 may receive a shaped voltage pulse (gamma ray data) and convert the voltage pulse into a digital number indicating the height of the pulse. The MCA module 304 may then categorize the pulse into an energy level range (a channel). The MCA module 304 may keep track of the number of pulses (or counts) received in a given channel, producing count patterns, or pulse height data. Thus, the MCA module 304 may be configured to produce pulse height data corresponding to the gamma ray data.

The radiation detection system 300 may include an amplifier module 306 generally operable to shape nuclear radiation measurements. For example, the amplifier module 306 may increase the magnitude of certain signals to highlight them over others, such that useful information from the detector output is maintained and distortion during signal processing is minimized. The radiation detection system 300 may further include a power supply 318 generally operable to provide power to the enriched CZT detector 300. The power supply 318 may be a high voltage power supply.

The radiation detection system 300 may include a collimator module 312 generally operable to focus or redirect radiation emitted from the MSR system to the CZT crystal module 302. In this way, the collimator module 312 may align gamma rays given off by constituents of the molten salt as they enter the radiation detection system 300, such that spectra may be produced. More specifically, the collimator module 312 may filter a stream of rays so that only those traveling parallel to a specified direction are allowed through to the CZT crystal module 302. In this way, the radiation detection system 300 is directionally sensitive, enabling analysis of a specific portion of the MSR system. For example, the collimator module 312 may be directed towards piping of a molten salt loop of an MSR system (e.g., that of FIG. 1). As another example, the collimator module 312 may be directed towards a drain tank and heat exchanger of an MSR system (e.g., that of FIG. 2). The collimator module 312 may serve as the housing for the radiation detection system 300. The collimator module 312 may be arranged partially within shielding of an MSR system, such that the shielding accommodates the collimator module 312 through a depression or divot. In one example, the collimator 312 is embedded in a shield wall of the MSR system, such as reactor enclosure 122, 230. However, one of ordinary skill in the art will appreciate that the collimator module 312 may be directed and proximal to any component of a high neutron flux region of a system and that the arrangements depicted herein (e.g., FIG. 1 and FIG. 2) serve as mere examples configurations.

The collimator module 312 may serve additional purposes and may include additional modules operable to facilitate thermal insulation and neutron filtering. The collimator module 312 may be connected to or include a thermal insulation module 314, generally operable to thermally insulate the components contained therein (e.g., the CZT crystal module 302). The radiation detection system 300 may be sensitive to extreme temperatures, in that it includes a CZT crystal. For example, the area and environment near a MSR system may be about 650° C. and the CZT crystal may be sensitive to temperatures above 130° C. Thus, the collimator 312 may be provided to thermally insulate the enriched CZT detector 300. As an example, the thermal insulation module 314 may be operable to maintain a temperature of about 100° C. within the collimator 312. In this regard, the thermal insulation module 314 may be a collimator composed of concrete, lead, mineral wool, fiberglass, ceramic fibers, cellular glass, or steel (or other thermally insulating material) hermetically sealing the radiation detection system 300 to a portion of the MSR system. In one example, the thermal insulation module 314 is a lithium or lead filter configured to serve as a thermal neutron filter or a neutron filter. The thermal insulation module 314 may be a hollow section within the collimator module 312 interposed between the component being interrogated and the radiation detection system 300. The hollow section may be a vacuum or filled with an inert gas (e.g., helium gas) or other low neutron absorbing gas.

The collimator module 312 may be connected to or include a neutron filter module 316 generally operable to filter background signals or noise that interfere with the detection of gamma rays. The neutron filter module 316 may be composed of a lithium glass. Lithium-based neutron filters may be advantageous due to thermal neutron absorption resulting in emission of alpha particles that do not interfere with gamma ray detection. In some embodiments, the neutron filter module 316 is a lithium-6 glass scintillator.

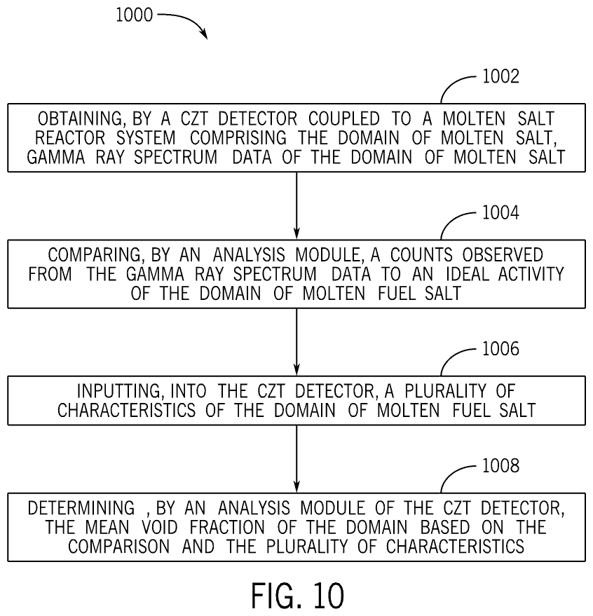

The radiation detection system 300 may include or be functionally connected to an analysis module 310, generally operable to process the signals received by the detector. In several embodiments, the analysis module 310 is operable to determine the void fraction based on the gamma ray data received and process by the radiation detection system 300. The analysis module 310 may be operable to facilitate the methods and process described in relation to FIG. 10.

In one example, the radiation detection system 300 is operable in gamma ray fields in the range of 1 to 10⁴ gamma rays cm⁻² s⁻¹. For example, the gamma ray field could be 1 to 10⁴, 1 to 10³, 1 to 10², 1 to 10, 1 to 9, 1 to 8, 1 to 7, 1 to 6, 1 to 5, 1 to 4, 1 to 3, 1 to 2, 2 to 10⁴, 3 to 10⁴, 4 to 10⁴, 5 to 10⁴, 6 to 10⁴, 7 to 10⁴, 8 to 10⁴, 9 to 10⁴, 10 to 10⁴, 10² to 10⁴, 10³ to 10⁴, 5 to 10³, 10 to 10³, 10² to 10³ gamma rays cm⁻² s⁻¹.

The example radiation detection system 300 may take many forms, for example, the radiation detection system 300 may be an enriched CZT detector and include a single CZT crystal or may include an array of CZT crystals, depending on the need.

The radiation detection system 300 may be or include a coplanar grid CZT gamma ray detector. In this example, the coplanar grid CZT gamma ray detector collects two separate anode signals from the CZT crystal. One signal indicates energy produced by charge motion in the CZT crystal and the other indicates the energy produced by both the charge motion and an interaction with a gamma ray. By subtracting the two signals using a differencing amplifier, the charge motion may be removed from the signal, increasing resolution. A shaping amplifier can then modify the pulse. Coplanar grid CZT gamma ray detectors are known, and those skilled in the art are familiar with the numerous ways in which such detectors may be configured and still fall within the scope of the disclosure.

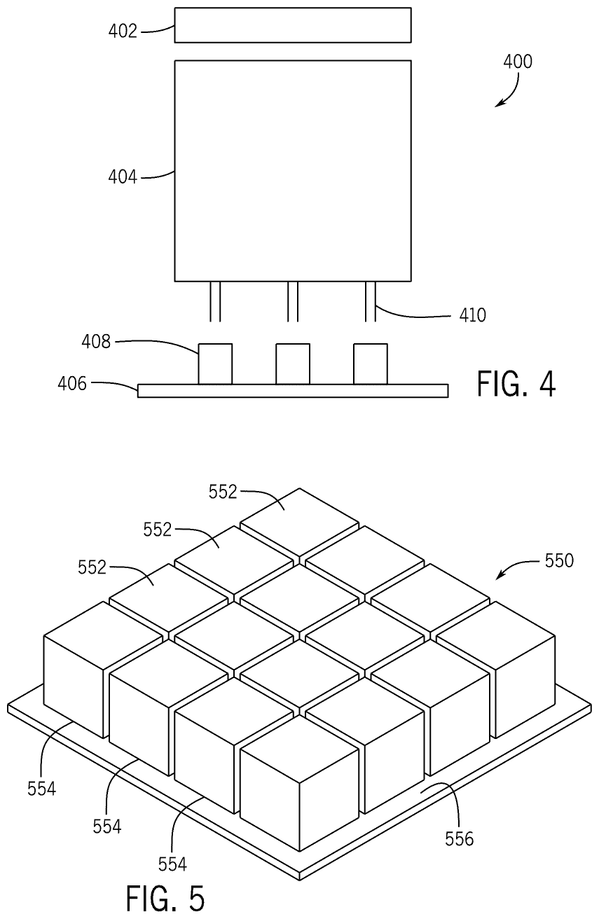

FIG. 4 illustrates an exploded view of an example enriched CZT detector 400. In one example, enriched CZT detector 400 is the previously discussed radiation detection systems. The example enriched CZT detector 400 may generally include a single enriched CZT crystal 402, a circuitry housing 404, a plurality of connects 410, a plurality of receivers 408 configured to receive the connectors 410, and a circuit board 406. The components illustrated in FIG. 4 may be generally operable to facilitate the operations and functions discussed with reference to FIG. 3. For example, the circuitry housing 404 may include means to communicate the charge emitted from the CZT crystal 402 to the circuit board 406 through the connects 410 and receivers 408. In this regard, the circuit board 406 may include or be functionally connected to an MCA module (e.g., MCA module 304), an amplifier (e.g., amplifier module 306), an analysis module (e.g., analysis module 310), and a power supply (e.g., power supply 318).

FIG. 5 illustrates an example enriched CZT detector array 500. In one example, enriched CZT detector 500 is the previously discussed radiation detection systems. The example enriched CZT detector array 500 includes an array of CZT crystals 552 mounted to a plurality of circuitry housing units 554 all mounted to a circuit board 556. The components illustrated in FIG. 5 may be generally operable to facilitate the operations and functions discussed with reference to FIG. 3. For example, the plurality of circuitry housing units 554 may include means to communicate the charge emitted from the array of CZT crystals 552 to the circuit board 556. In this regard, the circuit board 406 may include or be functionally connected to an MCA module (e.g., MCA module 304), an amplifier (e.g., amplifier module 306), an analysis module (e.g., analysis module 310), and a power supply (e.g., power supply 318).

While FIGS. 4 and 5 do not illustrate a collimator, one or ordinary skill in art will appreciate that the example enriched CZT detectors of FIGS. 4 and 5 may be equipped with a collimator.

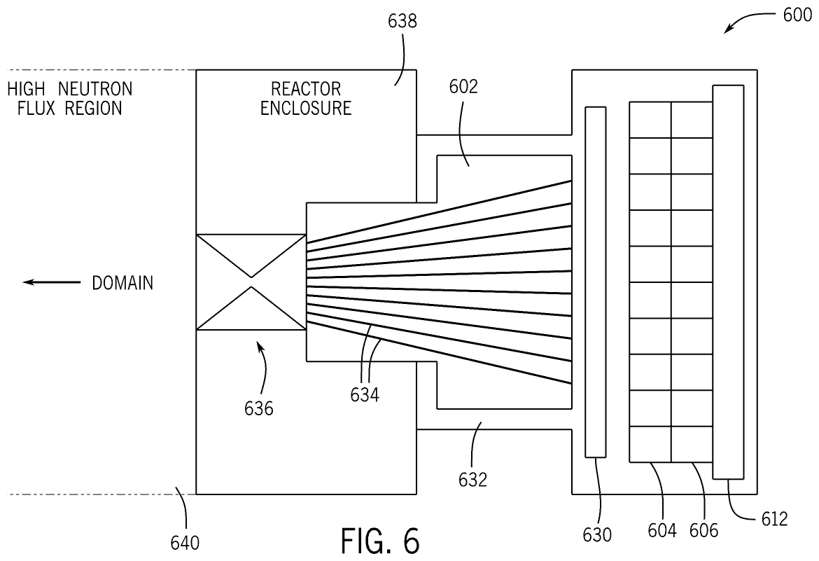

FIG. 6 illustrates a cross-sectional view of an example radiation detection system 600 installed in a reactor system. Radiation detection system 600 may be installed within a reactor enclosure 638 (substantially analogous to reactor enclosures 122, 230) of an MSR system proximal to a high neutron flux region 640 (e.g., areas within the reactor enclosure 638) and directed towards a domain. The domain may be an area proximal to any of the aforementioned salt-bearing components (e.g., molten salt loop 126, drain tank 108, heat exchanger 210, piping 212d, drain tank 208) such that the radiation detection system 600 receives gamma radiation therefrom.

The example radiation detection system 600 may include a front collimator 636, a rear collimator 602, an array of CZT crystals 604, a plurality of housing units 606, and a circuit board 612. The front collimator 636 may be configured to initially filter gamma radiation received from the domain within the high neutron flux region 640. The rear collimator 602 may be configured to further filter the gamma radiation received via through portions 634 and positioned proximal to the array of CZT crystals 604, the plurality of housing units 606, and the circuit board 612. The front collimator 636 and rear collimator 632 may be positioned between the array of CZT crystals 604 and the domain (i.e., the component being analyzed). The plurality of through portions 634 may be a vacuum or filled with a low neutron absorbing gas and configured to enable passage of gamma rays therein.

Example radiation detection system 600 may further include an insulation material 632 operable to insulate components of the radiation detection system to maintain an acceptable operating temperature. Insulating material 632 may be substantially analogous to thermal insulation module 314 redundant explanation of which is excluded for clarity. Radiation detection system 600 may further include a neutron filter 630 interposed between rear collimator 632 and the array of CZT crystal 604 and generally operable to filter out signal noise. Neutron filter 630 may be substantially analogous to neutron filter module 316 redundant explanation of which is excluded for clarity.

The array of CZT crystals 604 may include enriched CZT crystals that are substantially devoid of cadmium-113 as described herein, such that radiation data may be received without being overwhelmed by neutrons. The array of CZT crystals 604 may include the composition of enriched cadmium described in reference to the CZT crystal module 302 of FIG. 3. In this regard, the array of CZT crystals 604 may be operable to capture radiation data emitted from constituents of molten fuel salt of a molten salt reactor. The array of CZT crystals 604 may include a plurality of housing units 606 mounted to the array of CZT crystals 604 and generally operable to communicate the charge emitted from the array of CZT crystals 604 to the circuit board 612. The example enriched CZT detector system 600 may further include a frame and alignment grid configured to mount the array of CZT crystals 604 and plurality of housing units 606 to the circuit board 612. In this regard, the circuit board 612 may include or be functionally connected to an MCA module (e.g., MCA module 304), an amplifier (e.g., amplifier module 306), an analysis module (e.g., analysis module 310), and a power supply (e.g., power supply 318). Thus, the example radiation detection system 600 may be generally operable to capture and produce gamma ray spectrum data from a high neutron flux environment, such as that of an MSR system (e.g., MSR system 100).

As previously discussed, the example radiation detection system may include one or more enriched CZT detectors generally operable to capture gamma ray emissions from a high neutron flux area. As an example, the example enriched CZT detectors may be operable to capture gamma ray emissions consequence of radioactive decay and nuclear fission reaction occurring within molten salt of a molten salt reactor. Advantageously, this may be used for a variety of purposes. For example, the enriched CZT detectors disclosed may be used to detect a gamma ray spectrum within a reactor in real-time. In addition, the enriched CZT detector may be used to measure the thickness of a pipe or vessel wall that the gamma rays have traveled through. This may be advantageous for corrosion monitoring. In some embodiments, the enriched CZT detector and the resulting spectra may be used to calculate a density measurement in a fuel, such as a fuel salt or coolant salt. In some embodiments, the density measurement can be used to calculate if bubbles are forming in a liquid salt. In some embodiments, the enriched CZT detectors are utilized to provide a radiograph of a salt and/or a pipe. In other embodiments, multiple radiographs produced from the enriched CZT detectors positioned in multiple angles may be used to provide tomographic information.

### Void Fraction Determination

The radiation detection system and enriched CZT detectors disclosed herein may be operable to produce gamma ray spectra of a domain for determination of the void fraction within that domain (e.g., components of a nuclear reactor) (e.g., MSR system 100, 200) or other high neutron flux environment. In one example, the enriched CZT detector is coupled to a reactor enclosure of an MSR system in order to determine the void fraction within components of such a system (e.g., piping, drain tank, heat exchanger, etc.). Stated otherwise and as an example, gamma rays emanating from the flow of radioactive liquids and gases inside a designated volume may be absorbed or otherwise detected by an enriched CZT detector and used to estimate the relative space that consists of gas (i.e., void fraction). The void fraction at a single point may be referred to as the void fraction while the void fraction averaged over a volume may be referred to as the mean void fraction, unless indicated otherwise by the context. While the various example radiation detection system and example enriched CZT detectors previous discussed (i.e., CZT detector 132, CZT detector 134, CZT detector 136, radiation detection system 243, radiation detection system 253, radiation detection system 249, radiation detection system 300, enriched CZT detector 400, enriched CZT detector array 500, and radiation detection system 600) may be utilized to determine the mean void fraction of a volume, other gamma ray detecting devices may be used, for example, scintillation detectors, germanium-based detectors, solid-state detectors, or gas-filled detectors.

The method for determining the mean void fraction may include utilizing the molten fuel salt as a densitometry source, with peak intensity correlating with void fraction. Stated generally, the method includes collecting collimated spectra of molten salt (e.g., collected utilizing the enriched CZT detector), measuring the intensity of certain peaks in the spectrum against the expected activity of that peak, where the expected activity is a product of the specific activity, a volume fraction of the salt corresponding to the radionuclide that produces such a peak, and the volume of salt interrogated by the detector.

While the discussion that follows may describe determination of the mean void fraction of a chord of piping of a molten salt reactor, one of ordinary skill in the art will appreciate that the same parameters determined with reference to a chord of piping may be determined and used to calculate the mean void fraction of other portions of a reactor. As used herein, the void fraction at a point may be denoted as α, the void fraction averaged over a volume may be denoted as [symbol] α [symbol] and may be referred to as the mean void fraction, unless made clear by the contents.

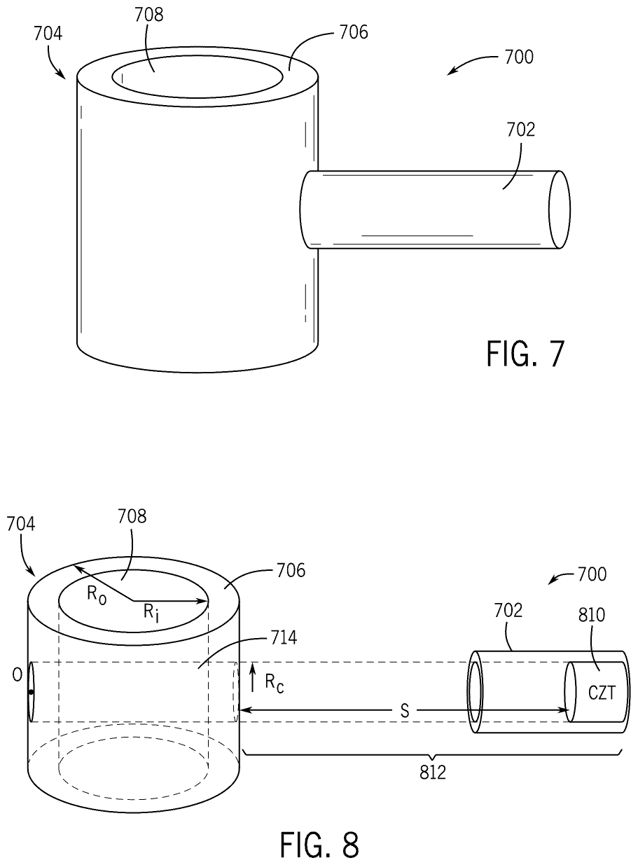

Initially, the method involves considering a section of pipe of a molten salt loop of an MSR system (e.g., MSR system 100). FIG. 7 illustrates an isometric view of an example radiation detection system 700, which includes an example radiation detection system configuration including a collimator 702 including a CZT detector affixed to a pipe 704 of a molten salt loop. The collimator 702 may be substantially analogous to collimator module 312, and/or rear collimator 602 redundant explanation of which is excluded for clarity. The method involves knowing the composition of the pipe 704 of the molten salt loop (e.g., SS316H stainless steel) and determining its outer radius (defined by the center of the pipe 704 extending to an outer edge of the pipe 704), referred to as R₀, and determining its inner radius (defined by the center of the pipe 704 extending to an inner edge of the pipe's surface 706), referred to as Rᵢ. During operation of an MSR system, the pipe of the molten salt loop will have a biphasic flow of fuel salt and void contained within the hollow section 708 of the pipe 704. The fuel salt has a specific activity, denoted aₛ, and a linear attenuation coefficient, denoted μₛ. The void may be assumed to have a negligible linear attenuation coefficient. In one example, pipe 704 is piping of molten salt loop 126 or any one of piping 212a, 212b, 212c, 212d, 212e.

The method further includes considering a cylindrical detector located proximal to, as an example extending perpendicular to, the pipe including a radius denoted Ra, with a front face, denoted Sd. In one example, the cylindrical detector is the radiation detection system or enriched CZT detectors and collimators described herein. Cartesian coordinates, with the center of the pipe at the origin, may be defined. In this regard, the front face of the detector can be defined as being located at coordinates (di+t+s, 0, 0). The detector may have an intrinsic efficiency curve denoted ε(E). Additionally, as in the case of the example radiation detection system and example enriched CZT detectors described herein, the cylindrical detector is well shielded from gamma and neutron radiation and highly collimated, such that only a cylindrical section or chord of the pipe is being interrogated. FIG. 8 illustrates a cutaway view of the radiation detection system 700 with the labeled variables described included and the enriched CZT detector 810 visible within collimator 702. FIG. 8 further illustrates an offset 812 between the enriched CZT detector 810 and the pipe 704, and the chord of pipe 714 being analyzed.

The offset 812 is the distance between the enriched CZT detector 810 and the surface 706 of the pipe 704. The offset 812 may be occupied by the collimator 702 extending from the enriched CZT detector 810 to the surface 706 of the pipe 704. The offset may be occupied by empty space or additional shielding of the reactor system. The enriched CZT detector 810 may be or may be a component of CZT detector 132, the CZT detector 134, the CZT detector 136, radiation detection system 243, radiation detection system 253, radiation detection system 249, radiation detection system 300, enriched CZT detector 400, enriched CZT detector array 500, or radiation detection system 600. The collimator 702 may partially penetrate the surface 706 of the pipe 704 or any shielding surrounding the pipe 704. The surface 706 of the pipe 704 may include a divot or a depression to accommodate the collimator 702. Advantageously, by extending the collimator 702 partially within the surface 706 of the pipe 704 or partially within the shielding of the reactor system, the enriched CZT detector 810 may receive the gamma ray radiation without being overwhelmed with counts.

As previously mentioned, the collimator 702 may be of a thickness and include a hollow section. The thickness of the collimator 702 may be varied to supply sufficient insulation to thermally insulate the enriched CZT detector 810. The hollow section may be filled with an inert gas or a low neutron absorbing gas to provide additional thermal insulation. In one example, the hollow section is a vacuum. The collimator 702 may be coupled to the surface 706 of the pipe 704. In some embodiments, the collimator 702 is hermetically sealed to the surface 706 of the pipe 704 such that it forms a watertight, airtight, and/or pressure tight seal. For example, the surface 706 may include a flange while the collimator 702 includes a corresponding flange, such that the collective flange assembly may be connected by fasteners (e.g., nut and bolt connection). The flange assembly may include a sealing component sandwich between the two flanges or nested within a ring grove. The sealing component may be a plastic, epoxy resin, glass, metal, or ceramic material configured to rest within the ring grove and thereby create a hermetic seal upon connection of the flange assembly. Advantageously, in this way, the collimator 702 may be removable attached to surface 706. As another example, the collimator 702 may be welded to the surface 706 of the pipe 704. In another example, the pipe 704 may include a threaded portion extending from the surface 706 and the collimator 702 may include a corresponding threaded interior portion, such that collimator 702 may be coupled to the pipe 704 by engaging or screwing the threaded portions together. In another example, the collimator 702 may be clamped or fastened to the surface 706 of the pipe 704. However, one of ordinary skill in the art will appreciate that there are other methods not specifically listed herein to create a hermetic seal between two components and that such methods are within the scope of the present invention. Stated otherwise, the collimator 702 may be coupled to the surface 706 of the pipe 704 in a variety of different ways known to those of ordinary skill in the art, such that a hermetic seal is created therebetween.

While FIGS. 7 and 8 illustrate a collimator 702 and enriched CZT detector 810 arranged towards a pipe, for example of a molten salt loop, one of ordinary skill in the art will appreciate that this is a mere example configuration. The method for determining the void fraction of the present invention may include alternative arrangements. Stated otherwise, while the parameters defined with relation to FIG. 8 (and the figures that follow) concern one specific arrangement, the parameters (i.e., those illustrated in FIG. 8) may be defined in substantially the same way for alternative arrangements. For example, the collimator 702 and enriched CZT detector 810 may be positioned on a drain tank or a heat exchanger of a molten salt reactor.

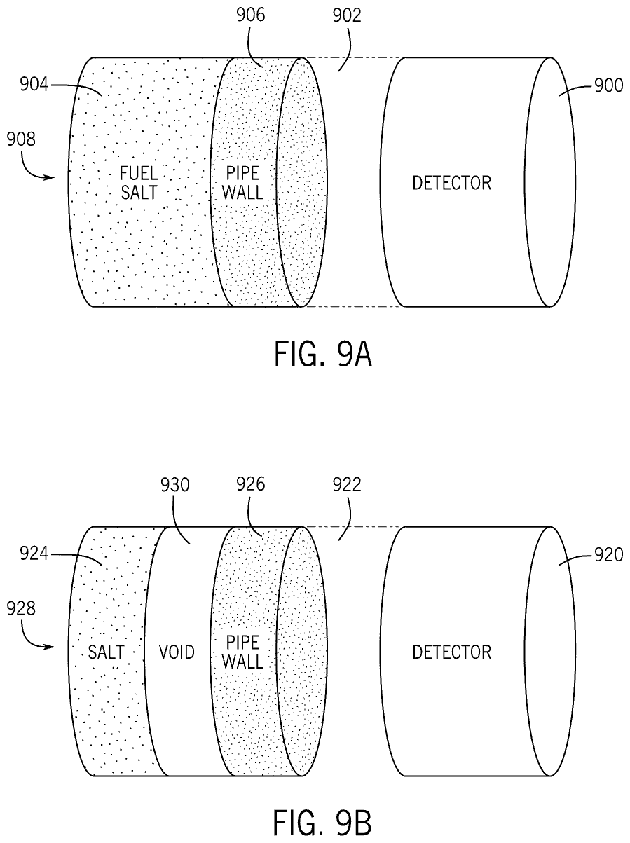

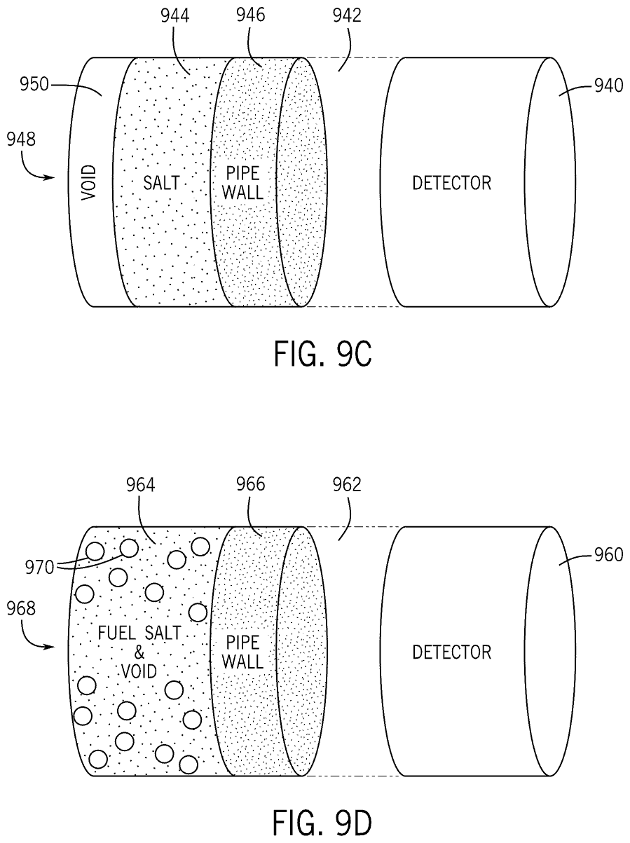

FIG. 9A illustrates a simplified depiction of a chord of piping 908 and an example radiation detection system 900. FIG. 9A serves to clarify what exactly is being interrogated by the radiation detection system 900 (e.g., CZT detector 132, the CZT detector 134, the CZT detector 136, radiation detection system 243, radiation detection system 253, radiation detection system 249, radiation detection system 300, enriched CZT detector 400, enriched CZT detector array 500, or radiation detection system 600). The radiation detection system 900 may include a collimator and an enriched CZT detector as previously described and may be operable to capture collimated radiation data from a chord 908 of piping 906 emitted from components of fuel salt 904 contained therein.

The void fraction may be defined as a function of both position and time. Regarding position, voids within the component being interrogated may experience turbulence. Stated otherwise, the composition being analyzed may not include a uniform or predictable distribution of void and liquid. For example, the flow of salt within a molten salt loop of a MSR system may be a turbulent flow of liquids and gases (i.e., void) due to the circulating nature of the system. Additionally, due to the chaotic mixing of the fluid (e.g., molten salt), the exact distribution of voids in the fluid may change rapidly with time, providing difficulties in obtaining a single-sensor-based void fraction determination. However, such chaotic mixing may occur homogeneously over time. In such a case, the spatial domain (denoted α̅(\vec{x})), that is the void fraction at each point (donated \vec{x}) may be defined by Equation 1.

$$\overline{α} ( \vec{x} ) = \frac{1}{{t}_{o}} {\int }_{0}^{{t}_{o}} α ( \vec{x} , t ) dt \qquad Equation 1$$

Equation 1 represents the average void fraction at \vec{x} over time to. However, to provide a more useful calculation, this quantity must be averaged over an entire interrogated domain, denoted [symbol] α [symbol] and referred to as the chordal mean void fraction. For clarity, the chord of the chordal mean void fraction refers to the analyzed or interrogated area being a chord across a section of pipe, such as that illustrated in FIG. 9A.

Thus, a method for determining a chordal mean void fraction may be determined. The method may comprise comparing measurements of gamma counts arising from molten fuel salt against an expected or “ideal” expected counts. The ideal or expected counts may be determined by experimentation or simulation. The ideal or expected counts may be that observed where the void fraction is zero. Initially, it may be assumed that decreasing fuel salt inventory, consequently increasing void fraction, would decrease the counts observed by the detector (e.g., enriched CZT detector). Thus, the expected counts, denoted C, of gammas of energy, denoted E, should follow a linear relationship with the ideal count number, denoted C₀(E), for example, by C(E)=(1−α)C₀(E). However, this is not the case, there is a countervailing tendency for the number of counts to decrease sub-linearly due to decrease self-attenuation with increasing void fraction. Additionally, by introducing void into the equation the geometric distribution of the molten fuel salt becomes relevant requiring inverse square effects to be taken into account.

The ideal or expected counts may be that observed where no void is present, that is, where the pipe or component being interrogated is completely filled with fuel salt. More specifically, the expected counts arising from the interrogated volume over a given amount of time may be derived as follows. The ideal or expected counts may be obtained through experimental data or simulation where the composition of fuel salt is precisely known. In several embodiments, the ideal counts are derived from a domain (e.g., chord of piping) having no void, thereby providing the expected counts. Considering the geometry illustrated in FIG. 8 and FIG. 9A where the origin of the coordinate system is at the center of projection of the collimator hole (i.e., a depression or divot in the pipe wall, component surface, or component shielding) on the back wall of the pipe of molten fuel salt. For clarity, the variables defined in the proceeding discussion may be made with reference to FIG. 8 and FIG. 9A. The counts observed at the detector, denoted C(E), may be defined as an integral of all counting elements, denoted dC(E), in the salt. Equation 2 defines the counts observed at the detector and Equation 3 defines each intensity element, dC. Stated otherwise, the domain of fuel salt analyzed (e.g., chord 714) may be divided into infinitesimally small samples of fuel salt. The counts observed by the detector (e.g., CZT detector 810) may be represented as the total effect of the counts arising from every sample of salt. This is represented mathematically by Equation 2. Additionally, where the counts arising from the infinitesimal volume of fuel salt, dC may be expanded into the five factor term of Equation 3.

$$C ( E ) = \int \int \int dC ( E ) \qquad Equation 2$$

$$dC ( E ) = [ intrinsic efficiency ] \times [ geometric efficiency ] \times [ shielding ] \times [ self attenuation ] \times {dC}_{0} ( E ) \qquad Equation 3$$

In this regard, dC₀(E) represents the ideal intensity of counts arising from an infinitesimal volume element. The intrinsic efficiency may be surveyed for a detector (e.g., enriched CZT detector), and is denoted as ε(E). The geometric efficiency for a point of fuel salt with x-component, denoted x, may be determined by Equation 4.

$$geometric efficiency = \frac{{R}_{C}^{2}}{4 {( {d}_{i} + S + t - x )}^{2}} \qquad Equation 4$$

Here, dᵢ=2Rᵢ and t is the thickness of the pipe wall (or wall or shielding of the component being analyzed) determined by t=R₀−Rᵢ, s is the standoff distance 812, and x is the distance of the point in question from the interior side of the back wall of the pipe. The shielding factor, S, is an application of the linear attenuation law and is constant with respect to position of infinitesimal element, due to the thickness of the shielding not changing based on position. S may be determined by Equation 5.

$$S = exp ( - {μ}_{st} t - {μ}_{pb} p - {μ}_{li - p} l ) \qquad Equation 5$$

Here, p represents the thickness of lead shielding and l represents the thickness of lithium-polymer shielding. μ_{pb} represents the linear attenuation coefficient of the lead shielding and μₗᵢ₋ₚ represents the linear attenuation coefficient of the lithium-polymer shielding. One of ordinary skill in the art will appreciate that where other shielding materials are used, their respective linear attenuation coefficients maybe be input into Equation 5.

The self-attenuation at a point depends on the average of the void fraction of the fuel salt between that point and the detector. The self-attenuation may be determined by Equation 6.

$$self attenuation = exp ( - {μ}_{s} [ 1 - {〈 α 〉}_{[ x , {d}_{i} ]} ] ( {d}_{i} - x ) ) \qquad Equation 6$$

Here, μₛ is the linear attenuation coefficient of the fuel salt. The self-attenuation may be expanded by Equation 7.

$$self attenuation = exp ( - {μ}_{s} [ 1 - \frac{1}{{d}_{i} - x} {\int }_{x}^{{d}_{i}} α ( {x}^{′} ) {dx}^{′} ] ( {d}_{i} - x ) ) \qquad Equation 7$$

The ideal counting element, C₀(E) may be proportional to a volume element dV scaled by two terms: Aₛ(E) and (1−α(x)), that is the complement of the local void fraction. Aₛ(E) may be a product of the volumetric activity of the fuel salt (with units of gammas per second per cm³), denoted aₛ(E) and the length of time that interrogations are taken over, denoted t₀. For clarity, the ideal counting element may be the ideal number of gammas of energy, E, expected in an interrogation. Importantly, the ideal counting element depends on the composition of fuel salt. Thus, Equation 8 may define the ideal counts or expected counts.

$${dC}_{0} ( E ) = {a}_{s} ( E ) ( 1 - α ( x ) ) dV \qquad Equation 8$$

By assuming that the collimator hole (i.e., the divot or depression in the shielding or component) is small enough that the medium is homogeneous for a given x, the counts observed at the detector may be simplified by two dimensions and defined by Equation 9.

$$C ( E ) = π {R}_{c}^{2} \int {dC}_{0} ( E ) \qquad Equation 9$$

Now, equations 2 and 9 may be combined to make Equation 10, which further defines the counts observed at the detector.

$$C ( E ) = \frac{π {R}_{c}^{4} {Sa}_{s} ( E ) ε ( E )}{4} {\int }_{0}^{{d}_{i}} \frac{1 - α ( c )}{{( {d}_{i} + t + s - x )}^{2}} \times exp ( - {μ}_{s} [ 1 - \frac{1}{{d}_{i} - x} {\int }_{x}^{{d}_{i}} α ( {x}^{′} ) {dx}^{′} ] ( {d}_{i} - x ) ) dx \qquad Equation 10$$

Thus Equation 10 may establish a means of determining the ideal or expected counts observed given characteristics of the domain being interrogated.

Importantly, the different spatial distributions of α(x) may change the number of counts observed at the detector. Stated otherwise, each point of void displaces a point that would have contributed to the counts, but since the contributed counts depend on position (both through inverse square and self-attenuation effects), so too does the geometric arrangement of void affect the observed counts. Due to α being an undetermined function of x, α cannot be found through a one-sensor method. Thus, in order to determine the void fraction, assumptions may be made to simply the relationship. These assumptions are in the form of spatial distributions of the void within the pipe. Namely, a lower bound on the possible void may be assumed, an upper bound on the possible void may be assumed, and an isotropic distribution of void across the domain may be assumed. Due to the flow of fluids in an MSR system likely being turbulent, mixing is expected to occur. Thus, in several embodiments, the distribution of void within the fuel salt is assumed to be uniform over the domain, such that α(x)= [symbol] α [symbol] everywhere and consequently giving rise to generalized exponential integral of Equation 13. This may be referred to as the isotropic distribution case and will be discussed in more detail later.

Notably, the fuel salt that contributes most to the observed counts is the fuel salt nearest the detector, as it is affected the least by self-attenuation and has the highest geometric efficiency. Additionally, the fuel salt that contributes the least to the observed counts is the fuel salt furthest from the detector for the same reasons. Thus, the effect of the fuel salt on the observed counts is monotonic increasing from the point furthest from the detector to the point closest to the detector. Stated otherwise, if the entirety of the void (referred to as a “slug” of void) were placed on the side of the fuel salt domain furthest from the detector, it would not decrease the counts observed at the detector as much as if the slug were placed on the side nearest the detector. The present invention anticipates and accommodates this interaction by providing an upper and lower bound calculation for the mean void fraction. Stated otherwise, the method for determining the mean void fraction may be altered to provide the upper and lower extreme void fraction possible, based on the observed counts, of the component being analyzed. For clarity, for the lower bound mean void fraction represents a scenario where the slug of void is directly interposed between the fuel salt and the detector, while the upper bound mean void fraction represents a scenario where the slug of void is positioned behind the fuel salt, furthest from the detector. Advantageously, by providing a method of determining the mean void fraction of components of a high neutron flux region, and operator is provided the option to determine the highest or the lowest mean void fraction possible given the observed counts. Stated otherwise, in situations where an operator is not comfortable making an assumption that the void and fuel salts exhibit an isotropic distribution, or where they desire to know the highest or lowest possible void fraction given the observed counts, an operator is provided with such an option. The present invention may provide three different mean void fractions based on the different assumptions, that is, an isotropic distribution of void and fuel salts, a non-uniform distribution of void to fuel salt where the void is interposed between the fuel salt and the detector, and a non-uniform distribution of void to fuel salt where the void is behind the fuel salt relative to the detector.

Addressing the lower bound mean void fraction first, FIG. 9B illustrates a simplified depiction of a chord of piping 928 in a lower bound scenario and a radiation detection system 920. FIG. 9B serves to illustrate a simplified view of the scenario where a slug of void is interposed between the fuel salt 924 and the pipe wall 926, effectively demonstrating an upper extreme of the mean void fraction based on the observed counts. For clarity, this shall be referred to as the lower bound case (i.e., the true void fraction is lower than the void fraction being constructed by the void fraction assay system) and exemplifies the scenario where the amount void is being overestimated. This may be advantageous for an overly cautious operator who desires to know the highest possible void given the radiation produced by the molten salt. The simplified depiction of the chord of piping 928 and void fraction assay system 920 may be substantially analogous to that of FIG. 9A and includes a void fraction assay system 920 (e.g., CZT detector 132, the CZT detector 134, the CZT detector 136, radiation detection system 243, radiation detection system 253, radiation detection system 249, radiation detection system 300, enriched CZT detector 400, enriched CZT detector array 500, or radiation detection system 600), a chord 928 of piping 926 including fuel salt 924. Importantly, FIG. 9B highlights a slug of void 930 positioned between the piping 926 and the fuel salt 924. The radiation detection system 920, may include a collimator and an enriched CZT detector, may be operable to capture collimated radiation data emitted from components of the fuel salt 924. Notably, due to the fuel salt's 924 position away from the void fraction assay system 920, it may contribute a lower number of counts.

In such as case, the lower bounds of the void fraction averaged over a volume (i.e., [symbol] α [symbol] where the slug of void 930 is directly interposed between the fuel salt 924 and the detector system 920 may be represented by Equation 11.

$$α ( x ) = \{ \frac{0 x < ( 1 - 〈 α 〉 ) {d}_{i}}{1 ( 1 - 〈 α 〉 ) {d}_{i} < x} \qquad Equation 11$$

Thus, this enables the combination of Equation 10 with Equation 11, to provide the relationship between the lower bounds of [symbol] α [symbol] and the observed counts in the lower bound case, denoted C_{low}(E). The combined equation may be simplified because the factor of (1−α(x)) in the integrand of Equation 10 means that the bounds of the integral may be reduced due to no counts being observed from regions of void. Additionally, because α=0 on the remaining region of salt, the mean void fraction in the exponential term of the integrand may be explicitly obtained as a function of position x. Thus, the lower bound on [symbol] α [symbol] is that which solves Equation 12

$${C}_{low} ( E ) = \frac{π {R}_{c}^{4} {Sa}_{s} ( E ) ε ( E )}{4} {\int }_{0}^{( 1 - 〈 α 〉 ) {d}_{i}} \frac{exp ( - {μ}_{s} [ ( 1 - 〈 α 〉 ) {d}_{i} - x ] )}{{( {d}_{i} + t + s - x )}^{2}} dx \qquad Equation 12$$

The solution to Equation 12 is denoted [symbol] α [symbol] _{low}. Equation 12 is obtained by combining Equation 10 with the assumptions in Equation 11. This integral may be analytically represented with the help of the generalized exponential integral of Equation 13.

$${E}_{n} ( x ) = {\int }_{1}^{∞} \frac{{e}^{- xt}}{{t}^{n}} dt \qquad Equation 13$$

Thus, Equation 14 may be obtained by solving the integral of Equation 12.

$${C}_{low} ( E ) / \frac{π {R}_{c}^{4} {Sa}_{s} ( E ) ε ( E )}{4} = exp ( {μ}_{s} [ 〈 α 〉 {d}_{i} + s + t ] ) \times ( \frac{{E}_{2} ( {μ}_{s} [ 〈 α 〉 {d}_{i} + s + t ] )}{〈 α 〉 {d}_{i} + s + t} - \frac{{E}_{2} ( {μ}_{s} [ {d}_{i} + s + t ] )}{{d}_{i} + s + t} ) \qquad Equation 14$$

Equation 14 therefore establishes a calculation for determining the chordal mean void fraction in the lower bound case utilizing a gamma ray detector (e.g., the radiation detection systems and enriched CZT detectors described herein).

Now addressing the upper bound mean void fraction, FIG. 9C illustrates a simplified depiction of a chord of piping 948 in an upper bound scenario and a radiation detection system 940. FIG. 9C serves to illustrates a simplified view of the scenario where the fuel salt 944 is interposed between the void slug 950 and the pipe wall 946, effectively demonstrating a lower extreme of the mean void fraction based on the observed counts. For clarity, this shall be referred to as the upper bound case (i.e., the true void fraction is higher than the void fraction being constructed by the void fraction assay system) and exemplifies the scenario where the amount of void is being underestimated. This may be advantageous for an operator who desires to know the lowest possible void given the radiation produced by the molten salt. Additionally, the lower bound case and the upper bound case may be combined to provide a range of possible voids given the radiation produced by the molten salt. The simplified depiction of the chord of piping 948 and void fraction assay system 940 may be substantially analogous to that of FIG. 9A and includes a void fraction assay system 940 (e.g., CZT detector 132, the CZT detector 134, the CZT detector 136, radiation detection system 243, radiation detection system 253, radiation detection system 249, radiation detection system 300, enriched CZT detector 400, enriched CZT detector array 500, or radiation detection system 600), a chord 948 of piping 946 including fuel salt 944. FIG. 9C highlights a fuel salt 944 positioned between the piping 946 and the slug of void 944. The radiation detection system 940, including a collimator and an enriched CZT detector, may be operable to capture collimated radiation data emitted from components of the fuel salt 944. Due to the fuel salt's 944 position close to the radiation detection system 940, it may contribute a higher number of counts.

A similar process to that of determining the chordal mean void fraction in the lower bound case may be used to determine the chordal mean void fraction in the upper bound case. In such as case, the upper bounds of the void fraction averaged over a volume (i.e., [symbol] α [symbol] ) where the fuel salt 944 is directly interposed between the slug of void 950 and the detector system 940 may include a spatial distribution of fuel salt α(x) as represented by Equation 15.

$$α ( x ) = \{ \frac{1 x < 〈 α 〉 {d}_{i}}{0 〈 α 〉 {d}_{i} < x} \qquad Equation 15$$

Thus, the upper bound of the chordal mean void fraction [symbol] α [symbol] is that which solves Equation 16. Equation 16 is obtained by combining equation 10 with the assumptions in Equation 15.

$${C}_{high} ( E ) = \frac{π {R}_{c}^{4} {Sa}_{s} ( E ) ε ( E )}{4} {\int }_{〈 α 〉 {d}_{i}}^{{d}_{i}} \frac{exp ( - {μ}_{s} [ {d}_{i} - x ] )}{{( {d}_{i} + t + s - x )}^{2}} dx \qquad Equation 16$$

Where the observed counts in the upper bound case, denoted C_{high}(E). The solution to equation 16 is denoted [symbol] α [symbol] _{high}. Equation 17 is obtained by solving the integral of Equation 16.

$${C}_{high} ( E ) / \frac{π {R}_{c}^{4} {Sa}_{s} ( E ) ε ( E )}{4} = exp ( {μ}_{s} ( s + t ) ) \times ( \frac{{E}_{2} ( {μ}_{s} [ s + t ] )}{s + t} - \frac{{E}_{2} ( {μ}_{s} [ ( 1 - 〈 α 〉 ) {d}_{i} + s + t ] )}{( 1 - 〈 α 〉 ) {d}_{i} + s + t} ) \qquad Equation 17$$

Equation 17 therefore establishes a calculation for determining the chordal mean void fraction in the upper bound case utilizing a gamma ray detector (e.g., the enriched CZT detector).

Now addressing a scenario where the fuel salt to void is distributed uniformly or isotropically (i.e., the isotropic mean void fraction). FIG. 9D illustrates a simplified depiction of a chord of piping 968 in an isotropic distribution scenario and a radiation detection system 960. FIG. 9D serves to illustrates a simplified view of the scenario where the void 970 is isotropically distributed within the fuel salt 964, effectively demonstrating a most likely mean void fraction based on the observed counts. For clarity, this shall be referred to as the isotropic case. The simplified depiction of the chord of piping 968 and void fraction assay system 960 may be substantially analogous to that of FIG. 9A and includes a void fraction assay system 960 (e.g., CZT detector 132, the CZT detector 134, the CZT detector 136, radiation detection system 243, radiation detection system 253, radiation detection system 249, radiation detection system 300, enriched CZT detector 400, enriched CZT detector array 500, radiation detection system 600, or radiation detection system 900, 920, 940, 960), a chord 968 of piping 966 including fuel salt 964. Importantly, FIG. 9D highlights void 970 distributed amongst the fuel salt 964. The void fraction assay system 960, comprising a collimator and an enriched CZT detector, may be operable to capture collimated radiation data emitted from components of the fuel salt 964.

Under the assumption that the void 970 distribution is isotropic across the entire measured domain, such that α(x)= [symbol] α [symbol] in the entire fuel salt 964 domain, the relationship between counts observed, denoted Cᵢₛₒ(E), and the chordal mean void fraction, denoted [symbol] α [symbol] ᵢₛₒ, may be established by Equation 18.

$${C}_{iso} ( E ) = \frac{π {R}_{c}^{4} {Sa}_{s} ( E ) ε ( E ) ( 1 - 〈 α 〉 )}{4} {\int }_{0}^{{d}_{i}} \frac{exp ( - {μ}_{s} ( 1 - 〈 α 〉 ) [ {d}_{i} - x ] )}{{( {d}_{i} + t + s - x )}^{2}} dx \qquad Equation 18$$

The solution to Equation 18 is denoted [symbol] α [symbol] ᵢₛₒ. Additionally, the integral relation can be expressed in terms of E₂ as defined in Equation 19. Equation 19 is obtained by solving the integral of Equation 18.

$${C}_{iso} ( E ) / \frac{π {R}_{c}^{4} {Sa}_{s} ( E ) ε ( E )}{4} = {( 1 - 〈 α 〉 )}^{2} exp ( {μ}_{s} ( 1 - 〈 α 〉 ) ( s + t ) ) \times ( \frac{{E}_{2} ( ( 1 - 〈 α 〉 ) {μ}_{s} ( s + t ) )}{( 1 - 〈 α 〉 ) ( s + t )} - \frac{{E}_{2} ( ( 1 - 〈 α 〉 ) {μ}_{s} ( {d}_{i} + s + t ) )}{( 1 - 〈 α 〉 ) ( {d}_{i} + s + t )} ) \qquad Equation 19$$

Equation 19 therefore establishes a calculation for determining the chordal mean void fraction in the isotropic case utilizing a gamma ray detector (e.g., the example radiation detection systems and enriched CZT detector described herein).

Therefore, the present invention provides a method for deriving the void fraction within a component placed in a high neutron flux region (e.g., a chord of piping of a molten salt loop of an MSR system). The method establishes a relationship between counts observed and the void fraction. The method involved capturing collimated radiation data from the component. This may be accomplished by utilizing the enriched CZT detector system or radiation detection systems described here. Advantageously, the radiation detection system and enriched CZT detectors (i.e., that with cadmium substantially devoid of cadmium-113) is operable to capture radiation data from the high neutron flux environment without being overwhelmed with counts in contrast to a non-enriched CZT detector which would produce worthless spectra. However, one of ordinary skill in the art will appreciate that the method for determining the void fraction may not require data from an enriched CZT detector and that other detector devices may be used. For example, silicon detectors, diamond detectors, germanium detectors, or other similar semiconductor detectors known in the art may be used.

Additionally, the method of the present disclosure provides multiple alternative calculations to provide operators with a mean void fraction based on the geometric configuration of fuel salts they are most comfortable assuming. As previously stated, the method involves making an assumption as to the spatial arrangement of fuel salts and void within the component being interrogated. While an isotropic distribution is the most likely scenario (due to the turbulent nature of the molten fuel salt), and upper bound and lower bound calculation may be provided. This is advantageous in scenarios where an operator desires to know the highest possible or lowest possible void fraction within the component being interrogated. Stated otherwise, an operator may be equipped with the best-case scenario (i.e., what the lowest possible void fraction is based on the observed counts) or the worst-case scenario (i.e., what the highest possible void fraction is based on the observed counts) depending on their desire. Of course, an operator may produce all three calculations (i.e., isotropic case, upper bound case, and lower bound case) to be provided with a thorough understanding of the void fraction within the component interrogated.

The present invention provides a method for determining the mean void fraction from gamma-rays arising from a radioactive fluid. Additional advantages include require only at least one detector placed proximal to the component being interrogated. This method may enable such a detector to accomplish more than one task at once by providing a means for determining a new quantification (i.e., void fraction) solely based on interpretation of possibly preexisting data.

FIG. 10 illustrates a flow diagram 1000 of an example method for determining a mean void fraction of a domain of molten fuel salt in a high neutron flux environment. At step 1002, a detector obtains gamma ray spectrum data of a domain of molten salt. The gamma ray spectrum data may be obtained by the radiation detection systems and enriched CZT detectors of the present disclosure (e.g., CZT detector 132, the CZT detector 134, the CZT detector 136, radiation detection system 243, radiation detection system 253, radiation detection system 249, radiation detection system 300, enriched CZT detector 400, enriched CZT detector array 500, radiation detection system 600, or radiation detection system 900, 920, 940, 960). The enriched CZT detector may be an array or may be a single CZT detector. The domain may be chord of piping with the unknown void fraction may be a chord of the inner volume of piping to a molten salt loop of an MSR system, such as that illustrated in FIG. 1. However, as illustrated in FIG. 2 and as apparent in light of the present disclosure, one of ordinary skill in the art will appreciate that other domains of high neutron flux environments may be interrogated. Stated otherwise, while the present disclosure utilizes piping to a molten salt loop of an MSR system as the primary example, other components to other reactor systems and high neutron flux environments may be interrogated. For example, the detector may be arranged proximal to a drain tank (e.g., drain tank 108, 208), a heat exchanger (e.g., heat exchanger 106, 210), reactor access vessel (e.g., reactor access vessel 110, 212), or other component of interest such that radiation data is obtained and void fraction is determined.

At step 1004, an analysis module compares counts observed from the gamma ray spectrum data to that of an ideal activity of the domain of molten fuel salt. In one example, the analysis module is analysis module 306. In one example, a multichannel analyzer module (e.g., MCA 304) of the detector converts the gamma ray spectrum data to voltage pulses. For example, the multichannel analyzer module can use techniques such as those described above for converting the gamma ray spectrum data to voltage pulses. These voltage pulses may then be categorized and organized into counts. Advantageously, this enables the counts to be compared to the expected activity, enabling mean void fraction determination.

At step 1004, the analysis module of the detector compares the counts observed from the gamma ray spectrum data obtained to the expected activity of the domain being interrogated. The expected activity may be the counts one would expect to observe when interrogating that domain without the presence of void. Stated otherwise, the expected activity is the expected counts or ideal counts that would be observed if there was no void present in the interrogated domain (i.e., chord of piping). The comparison is useful because the fuel salt is expected to give off gamma radiation, but the void is not expected to give off gamma radiation. Therefore, by comparing the observed counts to the expected counts, the void may be determined.

At step 1006, a plurality of characteristics of the domain of the molten fuel salt is input into the CZT detector. In one example, the analysis module receives as inputs one or more of a variety of characteristics of the domain being interrogated and the system doing the interrogation, such characteristics related to the expected activity. For example, the characteristics of the domain may include the thickness of the component housing the fuel salt (i.e., the thickness of the piping of the molten salt loop), the composition of the component (e.g., pipe) itself along with its associated attenuation coefficient, the turbulent nature of the salt occupying the pipe, and the specific activity of the fuel salt and its constituents, the mass flow rate of the fuel salt. For example, the characteristics of the system doing the interrogation may include the type of detector doing the observation (e.g., enriched CZT detector), the distance of the detector to the domain being interrogated, the collimation caused by the detector system, and the level of shielding. The expected activity may be derived through experimentation or simulation. By ensuring that the expected activity, or the expected counts, is calibrated to the characteristics of the domain being interrogated, a proper comparison can be made. Stated otherwise, the expected counts are those which would be observed at the same interrogated domain if no void fraction were present. Thus, it is important to provide data as to the characteristics surrounding the interrogated domain and apply it to the expected activity. By providing this data, the domain with an unknown void fraction may be determined.

The geometric configuration of fuel salt to void plays an important role. This is due to the tendency of fuel salt closest to the detector to contribute more to the observed counts than fuel salt furthest from the detector. Therefore, as illustrated in FIGS. 9A-9D, different assumption as to the geometric configuration of salt may be made to provide different void fraction calculations. For example, it may be assumed that the entirety of the void is positioned in front of the fuel salt, relative to the detector, to provide a lower bound case, or the smallest possible void given the observed counts. As another example, it may be assumed that the entirety of the void is positioned behind the fuel salt, relative to the detector, to provide a higher bound case or the largest possible void given the observed counts. Finally, it may be assumed that the distribution of void and fuel salt is isotropic to provide the most probable void fraction given the observed counts.

At step 1008, the analysis module of the CZT detector determines the mean void fraction of the domain (e.g., chord of piping of an MSR system) based on the comparison and the plurality of characteristics. In one example, the analysis module conducts the comparison and includes or is provided the characteristics data and the expected count data. The determination of the void fraction involves utilizing the molten fuel salt as a densitometry source as opposed to the prior art which may utilize some other radioactive material as the densitometry source. Advantageously, this obviates the need to use an external substance as the densitometry source, effectively simplify the system. The comparison may involve establishing a mathematical relationship between the observed counts and the void fraction given a variety of parameters. The comparison further takes into account the position of the voids within the fuel salt and the time of interrogation. The comparison further takes into account the unintuitive relationship between the counts observed and the amount of void within the domain, relative to the ideal or expected activity (i.e., the tendency for the number of counts to decrease sub-linearly due to decreased self-attenuation with increasing void fraction). In several embodiments, the determination of step 1008 utilizes Equation 10, while in other embodiments, Equation 14 or Equation 17 may be used based on the need. In one example, the analysis module conducting the comparison and making the determination is analysis module 310 or computer 1100.

Reactor systems of the disclosure can include an intranet-based computer system that is capable of communicating with various software. A computer system includes any type of computing device and/or communication device. Examples of such a system can include, but are not limited to, super computers, a processor array, distributed parallel system, a desktop computer with LAN, WAN, Internet or intranet access, a laptop computer with LAN, WAN, Internet or intranet access, a smart phone, a server, a server farm, an android device (or equivalent), a tablet, smartphones, and a personal digital assistant (PDA). Further, as discussed above, such a system can have corresponding software (e.g., user software, detector device software). The software of one system can be a part of, or operate separately but in conjunction with, the software of another system. Embodiments of the reactor system include a computer system.

Embodiments of the computer system include a storage repository. The storage repository can be a persistent storage device (or set of devices) that stores software and data. Examples of a storage repository can include, but are not limited to, a hard drive, flash memory, some other form of solid-state data storage, or any suitable combination thereof. The storage repository can be located on multiple physical machines, each storing all or a portion of a database, protocols, algorithms, and/or other stored data according to some example embodiments. Each storage unit or device can be physically located in the same or in a different geographic location. In embodiments, the storage repository may be stored locally, or on cloud-based servers such as Amazon Web Services.

In one or more example embodiments, the storage repository stores one or more databases, AI Platforms, protocols, algorithms, and stored data. The protocols can include any of a number of communication protocols that are used to send and/or receive data between the processor, datastore, memory and the user. A protocol can be used for wired and/or wireless communication. Examples of protocols can include, but are not limited to, Modbus, profibus, Ethernet, and fiberoptic.

Systems of the computer system can include a hardware processor. The processor of the executes software, algorithms, and firmware in accordance with one or more example embodiments. The processor can be a central processing unit, a multi-core processing chip, SoC, a multi-chip module including multiple multi-core processing chips, or other hardware processor in one or more example embodiments. The processor is known by other names, including but not limited to a computer processor, a microprocessor, and a multi-core processor. The processor can also be an array of processors.

In one or more example embodiments, the processor executes software instructions stored in memory. Such software instructions can include performing analysis on data received from the database, calculation of corrosion, and so forth. The memory includes one or more cache memories, main memory, and/or any other suitable type of memory. The memory can include volatile and/or non-volatile memory.

The processing system can be in communication with a computerized data storage system which can be stored in the storage repository. The data storage system can include a non-relational or relational data store, such as a MySQL or other relational database. Other physical and logical database types could be used. The data store may be a database server, such as Microsoft SQL Server, Oracle, IBM DB2, SQLITE, or any other database software, relational or otherwise. The data store may store the information identifying syntactical tags and any information required to operate on syntactical tags. In some embodiments, the processing system may use object-oriented programming and may store data in objects. In these embodiments, the processing system may use an object-relational mapper (ORM) to store the data objects in a relational database. The systems and methods described herein can be implemented using any number of physical data models. In one example embodiment, an RDBMS can be used. In those embodiments, tables in the RDBMS can include columns that represent coordinates. The tables can have pre-defined relationships between them. The tables can also have adjuncts associated with the coordinates.

In embodiments, the computer systems of the disclosure can include one or more I/O (input/output) devices that allow a user to enter commands and information into the system, and also allow information to be presented to the user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a display, a monitor, or projector), speakers, a printer, and a network card.

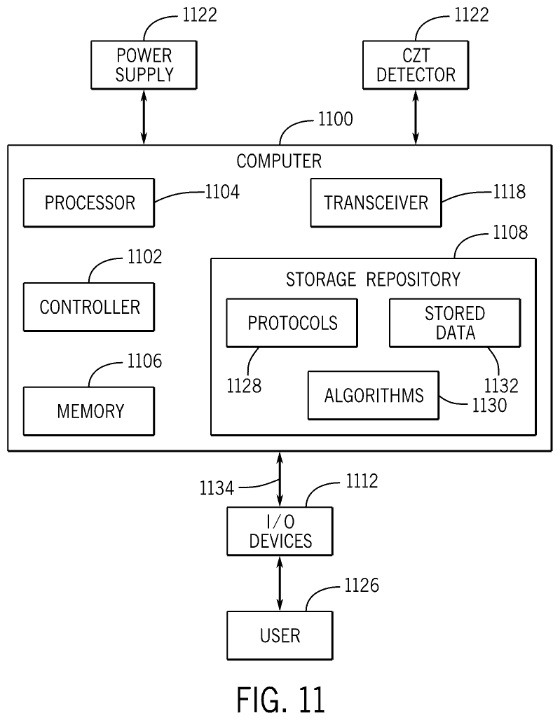

FIG. 11 illustrates an example computer system 1100 that can be included in the reactor system of the disclosure. The example computer system of FIG. 11 may be the analysis module 310 of the example enriched CZT detector 300. The example computer system may comprise a computer 1100 with a controller 1102, a processor 1104, a memory 1106, a transceiver 1118 and a storage repository 1108 which can comprise protocols 1128, stored data 1132, and algorithms 1130. The transceiver 1118 may send and receive data. Input/Output devices 1112 are connected to the computer 1100 through wired or wireless means 1134. The computer 1100 can receive power from a power supply 1122. A bus (not shown) can allow the various components and devices to communicate with one another. A bus can be one or more of any of several types of bus structures, including a memory bus or memory controller, a peripheral bus, an accelerated graphics port, and a processor or local bus using any of a variety of bus architectures. A bus can include wired and/or wireless buses. The components shown in FIG. 11 are not exhaustive, and in some embodiments, one or more of the components shown in FIG. 11 may not be included in a specific embodiment. Further, one or more components shown in FIG. 11 can be rearranged. It should also be understood that in embodiments, the various elements shown here can be located together or located remotely from each other. For example, the database could be stored in a different location, such as on a server, from the processor used by the dashboard system or routing system. The enriched CZT detector can also be in a different location, such as in another room, in another building, etc. from the computer.

Notably the computer 1100 may be the analysis module 310 of the example enriched CZT detector 300 and be operable to facilitate the steps associated with the method for determining the void fraction of an interrogated domain. In this regard, the computer 1100 may be operable to automatically compute the void fraction given the data obtained by the enriched CZT detector of void fraction assay system (e.g., CZT detector 132, the CZT detector 134, the CZT detector 136, radiation detection system 243, radiation detection system 253, radiation detection system 249, radiation detection system 300, enriched CZT detector 400, enriched CZT detector array 500, radiation detection system 600, or radiation detection system 900, 920, 940, 960). In several embodiments, the stored data 1132 of the storage repository 1108 may include the expected activity or ideal counts for any particular domain. In several embodiments, the algorithms 1130 of the storage repository 1108 may include the variety of Equations disclosed herein in order to determine the void fraction given the observed counts. As illustrated in FIG. 11, the CZT detector 1122 may be functionally connected to the computer 1100, such that the collimated data captured by the detector 1122 may be fed into the computer 1100 for processing. The CZT detector 1122 may be CZT detector 132, the CZT detector 134, the CZT detector 136, radiation detection system 243, radiation detection system 253, radiation detection system 249, radiation detection system 300, enriched CZT detector 400, enriched CZT detector array 500, radiation detection system 600, or radiation detection system 900, 920, 940, 960. In one example, the computer 1100 is included in a circuit board of the detector system. For example, the computer 110 may be included in or functionally connected to the circuit board 406, circuit board 556, or the circuit board 612.

Various techniques are described herein in the general context of software. Generally, software includes routines, programs, objects, components, data structures, and so forth that perform particular tasks or implement particular abstract data types. An implementation of these modules and techniques can be stored on or transmitted across some form of computer readable media. Computer readable media is any available non-transitory medium or non-transitory media that is accessible by a computing device. By way of example, and not limitation, computer readable media includes computer storage media.

Those of ordinary skill in the art will appreciate that CZT detectors can have any of a number of configurations. In any case, a user can be aware of the devices, components, ratings, positioning, and any other relevant information regarding a CZT detector. The CZT detector can also include a number of other components generally considered part of a CZT detector system which are not shown for conciseness.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A radiation detection system comprising
a cadmium zinc telluride (CZT) detector comprising at least one enriched CZT crystal;
a collimator assembly coupled to and interposed between the CZT detector and a molten salt reactor system and operable to filter gamma rays emitted from radionuclides of a domain of the molten salt reactor system thereby producing filtered gamma rays;
wherein the CZT detector is operable to receive the filtered gamma rays and produce spectroscopy data representative of an inventory of radionuclides within the domain of the molten salt reactor system from the filtered gamma rays; and
wherein the at least one enriched CZT crystal is substantially devoid of cadmium-113 isotopes.

2. The radiation detection system of claim 1, further comprising an analysis module operable to determine a void fraction of the domain of the molten salt reactor system by comparing a measurement of gamma counts from the spectroscopy data to an ideal gamma count.

3. The radiation detector system of claim 2, wherein the ideal gamma count is an expected observed gamma count of the domain with a void fraction of zero.

4. The radiation detector system of claim 1, wherein the domain of the molten salt reactor system is in a high neutron flux region of the molten salt reactor system.

5. The radiation detector system of claim 1, wherein the domain is an internal volume of piping of a molten salt loop of the molten salt reactor system.

6. The radiation detector system of claim 1, wherein the domain is an internal volume of a drain tank of the molten salt reactor system.

7. The radiation detector system of claim 1, wherein the domain is an internal volume of a primary heat exchanger of the molten salt reactor system.

8. The radiation detector system of claim 3, wherein the analysis module is further operable to consider characteristics of the domain of the molten salt reactor system.

9. The radiation detector system of claim 8, wherein the characteristics comprise a composition of the molten salt disposed within the domain and a composition of a vessel housing the molten salt disposed within the domain.

10. The radiation detector system of claim 9, wherein the characteristics further comprise a distance between the CZT detector and the domain, a geometric shape of the vessel housing the molten salt, a radius of the vessel housing the molten salt, and a thickness of walls of the vessel housing the molten salt.

11. The radiation detector system of claim 2, wherein the analysis module is further operable to determine a mean void fraction of the domain of the molten salt reactor system by comparing the measurement of gamma counts from the spectroscopy data over a time period of taking the spectroscopy data.

12. The radiation detector system of claim 11, wherein the mean void fraction is determined based on an upper bound determination or a lower bound determination.

13. The radiation detector system of claim 11, wherein the mean void fraction is an isotropic mean void fraction determined based on an isotropic flow assumption.

14. The radiation detector system of claim 1, wherein the CZT crystal comprises at least 99% of cadmium-106, cadmium-108, cadmium-110, cadmium-111, cadmium-112, cadmium-114, cadmium-116, or combinations thereof.

15. The radiation detector system of claim 1, wherein the CZT crystal consists essentially of cadmium-116.

16. The radiation detector system of claim 1, wherein
the CZT crystal operable to interact with the filtered gamma rays and produce a charged pulse; and
the CZT detector further comprises a multichannel analyzer module operable to convert the charged pulse from the CZT crystal into a shaped voltage pulse and an amplifier module operable to shape nuclear radiation measurements.

17. The radiation detector system of claim 1, wherein the collimator assembly comprises a thermal insulation material operable to thermally insulate the CZT detector.

18. The radiation detector system of claim 11, wherein the collimator assembly further comprises a neutron filter operable to filter background noise from contacting the CZT detector.

19. A method for determining a mean void fraction of a domain of molten fuel salt in a high neutron flux environment comprising:
obtaining, by a cadmium zinc telluride (CZT) detector coupled to a molten salt reactor system comprising the domain of molten fuel salt, gamma ray spectrum data of the domain of molten fuel salt;
wherein the CZT detector comprises at least one enriched CZT crystal;
comparing, by an analysis module, a counts observed from the gamma ray spectrum data to an ideal activity of the domain of molten fuel salt;
inputting into the CZT detector, a plurality of characteristics of the domain of molten fuel salt; and
determining, by an analysis module of the CZT detector, the mean void fraction of the domain based on the comparison and the plurality of characteristics.

20. The method of claim 19, wherein
the ideal gamma count is an expected observed gamma count of the domain with a void fraction of zero; and
the plurality of characteristics comprises a composition of the molten fuel salt disposed within the domain, a composition of a vessel housing the molten fuel salt, a distance between the CZT detector and the domain of molten fuel salt, a geometric shape of the vessel, a radius of the vessel, and a thickness of walls of the vessel.
